(19) United States
(12) Patent Application Publication
(10) Pub. No.: US 2018/0233726 A1
(43) Pub. Date: Aug. 16, 2018

(54) SEPARATOR FOR NON-AQUEOUS SECONDARY BATTERY AND NON-AQUEOUS SECONDARY BATTERY

(71) Applicant: TEIJIN LIMITED, Osaka (JP)

(72) Inventor: Yu NAGAO, Osaka (JP)

(73) Assignee: TEIJIN LIMITED, Osaka (JP)

(21) Appl. No.: 15/893,914

(22) Filed: Feb. 12, 2018

(30) Foreign Application Priority Data
Feb. 16, 2017 (JP) 2017-026979
Feb. 16, 2017 (JP) 2017-026980

(51) Int. Cl. H01M 2/16; H01M 10/0525

(52) U.S. Cl. CPC H01M 2/166; H01M 2220/30; H01M 2/1686; H01M 10/0525

(57) ABSTRACT

A separator for a non-aqueous secondary battery including a porous substrate, and a heat-resistant porous layer that is provided on one side or both sides of the porous substrate, in which the heat-resistant porous layer contains (1) a binder resin. (2) zinc oxide particles, and (3) one or more heat-resistant filler selected from the group consisting of a metal hydroxide and a metal oxide other than zinc oxide, and the content of the zinc oxide particles is 2% by mass or more and less than 100% by mass with respect to the total content of the zinc oxide particles and the heat-resistant filler, or a separator for a non-aqueous secondary battery including a porous substrate, and a heat-resistant porous layer that is provided on one side or both sides of the porous substrate and contains a binder resin and hexagonal plate-shaped zinc oxide particles.

### CROSS-REFERENCE TO RELATED APPLICATIONS

This application claims priority under 35 USC 119 from Japanese Patent Application No. 2017-026979 filed on Feb. 16, 2017, and Japanese Patent Application No. 2017-026980 filed on Feb. 16, 2017, the disclosures of which are incorporated by reference herein.

### BACKGROUND

### Technical Field

The present invention relates to a separator for a non-aqueous secondary battery and a non-aqueous secondary battery.

### Related Art

Non-aqueous secondary batteries, which are represented by lithium ion secondary batteries, are widely used as mobile power sources or used for power storage in terms of having a high energy density, a flexible and light structure, and a longer life than that of other batteries. Recently, there is a need for the non-aqueous secondary batteries to have a higher energy density. Based on this, emphasis is placed on ensuring safety.

Separators have significant roles in ensuring the safety of non-aqueous secondary batteries such as lithium ion secondary batteries. Specifically, it is desired that a separator has a function of shutting down a current by closing the pores of the membrane in a case in which the heat resistance of the membrane itself and the temperature of the battery are increased. As the technology associated with heat resistance, there is suggested a separator having a porous layer containing a filler such as aluminum hydroxide and a heat-resistant resin such as meta-type wholly aromatic polyamide formed on a micro-porous polyethylene membrane (for example, see WO 2008/062727 and WO 2008/156033), a separator having a porous layer containing magnesium hydroxide and polyvinylidene fluoride type resins formed on a micro-porous polyolefin membrane (for example, see WO 2014/021293), and a separator having a particle-containing resin layer composed of inorganic particles and a resin formed on a micro-porous polyolefin membrane (for example, see WO 2015/068325 and WO 2015/097953).

### SUMMARY

### Technical Problem

In a separator having a porous layer containing a heat-resistant filler such as aluminum hydroxide, a very small amount of water present in a battery impregnated with an electrolyte solution reacts with an electrolyte, thereby deteriorating the liquid stability, which may induce the decomposition of the electrolyte solution and the electrolyte to generate gas. The phenomenon results in swelling of the battery itself and deformation of the battery, which is problematic.

The first embodiment of the invention has been made in view of the above circumstances, and an object of the invention is to provide a separator for a non-aqueous secondary battery including a porous layer containing a heat-resistant filler such as aluminum hydroxide in which the generation of gas is suppressed in the case of producing a battery and which has excellent heat resistance.

In the conventional separator as described above, it is necessary to perform a step of applying a particle-containing coating liquid which contains a filler and a binder resin to a micro-porous polyethylene membrane and a step of removing a solvent. However, the viscosity of the coating liquid may be increased over time by the aggregation of the fillers depending on the state of the coating liquid and the interaction between the filler and the binder resin in some cases. As a result, fluctuation in the membrane thickness of the separator is large and its appearance becomes poor, which is problematic.

The second embodiment of the invention has been made in view of the above circumstances, and an object of the invention is to provide a separator for a non-aqueous secondary battery having little fluctuation in the membrane thickness and a favorable appearance.

### Solution to Problem

The first embodiment of the present invention employs the following configurations.

1. A separator for a non-aqueous secondary battery, containing:

a porous substrate; and

a heat-resistant porous layer that is provided on one side or both sides of the porous substrate, wherein:

the heat-resistant porous layer contains (1) a binder resin, (2) zinc oxide particles, and (3) one or more heat-resistant filler selected from the group consisting of a metal hydroxide and a metal oxide other than zinc oxide, and

a content of the zinc oxide particles is 2% by mass or more and less than 100% by mass with respect to a total content of the zinc oxide particles and the heat-resistant filler.

2. The separator for a non-aqueous secondary battery according to above 1, wherein the heat-resistant filler is one or more heat-resistant filler selected from the group consisting of magnesium hydroxide, aluminum hydroxide, aluminum oxide, boehmite, and magnesium oxide.

3. The separator for a non-aqueous secondary battery according to above 1 or 2, wherein an average particle diameter of the zinc oxide particles is from 0.1 μm to 1 μm.

4. The separator for a non-aqueous secondary battery according to any one of the above 1 to 3, wherein:

the binder resin is a copolymer including a vinylidene fluoride monomer unit and a hexafluoropropylene monomer unit, and

the binder resin is a polyvinylidene fluoride type resin including the hexafluoropropylene monomer unit in an amount of from 1.0% by mol to 7.0% by mol with respect to a total amount of the vinylidene fluoride monomer unit and the hexafluoropropylene monomer unit.

5. The separator for a non-aqueous secondary battery according to above 4, wherein a weight-average molecular weight of the polyvinylidene fluoride type resin is from 600,000 to 3,000,000.

6. The separator for a non-aqueous secondary battery according to any one of the above 1 to 5, wherein a total content of the zinc oxide particles and the heat-resistant filler in the heat-resistant porous layer is from 30% by volume to 85% by volume.

7. A non-aqueous secondary battery containing:

a positive electrode,

a negative electrode, and

the separator for a non-aqueous secondary battery according to any one of the above 1 to 6, which is disposed between the positive electrode and the negative electrode,

wherein an electromotive force is obtained by lithium doping and dedoping.

Further, the second embodiment of the invention employs the following configurations.

1. A separator for a non-aqueous secondary battery, containing:

a porous substrate; and

a heat-resistant porous layer that is provided on one side or both sides of the porous substrate and contains a binder resin and hexagonal plate-shaped zinc oxide particles.

2. The separator for a non-aqueous secondary battery according to above 1, wherein an average particle diameter of the hexagonal plate-shaped zinc oxide particles is from 0.1 μm to 1 μm.

3. The separator for a non-aqueous secondary battery according to above 1 or 2, wherein:

the binder resin is a copolymer including a vinylidene fluoride monomer unit and a hexafluoropropylene monomer unit, and

the binder resin is a polyvinylidene fluoride type resin including the hexafluoropropylene monomer unit in an amount of from 1.0% by mol to 7.0% by mol with respect to a total amount of the vinylidene fluoride monomer unit and the hexafluoropropylene monomer unit.

4. The separator for a non-aqueous secondary battery according to above 3, wherein a weight-average molecular weight of the polyvinylidene fluoride type resin is from 600,000 to 3,000,000.

5. A non-aqueous secondary battery containing:

a positive electrode,

a negative electrode, and

the separator for a non-aqueous secondary battery according to any one of the above 1 to 4, which is disposed between the positive electrode and the negative electrode,

wherein an electromotive force is obtained by lithium doping and dedoping.

### Advantageous Effects of Invention

According to the first embodiment of the invention, there is provided a separator for a non-aqueous secondary battery including a porous layer containing a heat-resistant filler such as aluminum hydroxide in which the generation of gas is suppressed in the case of producing a battery and which has excellent heat resistance.

According to the second embodiment of the invention, there is provided a separator for a non-aqueous secondary battery including a heat-resistant porous layer containing a filler and a binder resin which has little fluctuation in the membrane thickness and a favorable appearance.

### BRIEF DESCRIPTION OF THE DRAWINGS

FIG. 1 is a view schematically illustrating three diagonal lines of a hexagonal surface of a hexagonal plate-shaped particle according to the first embodiment or a hexagonal plate-shaped zinc oxide particle according to the second embodiment.

### DESCRIPTION OF EMBODIMENTS

Hereinafter, the first and second embodiments of the present invention will be described. Note that the following explanation and examples merely illustrate the invention and are not intended to limit the scope of the invention. Unless otherwise noted, the term “the present disclosure” includes both the first and second embodiments.

Further, in the present specification, the numerical range indicated by “to” refers to a range including respective values presented before and after “to” as a minimum and a maximum, respectively.

<Separator for a Non-Aqueous Secondary Battery of First Embodiment>

The separator for a non-aqueous secondary battery of the first embodiment includes at least a porous substrate and a heat-resistant porous layer that is provided on one side or both sides of the porous substrate. The heat-resistant porous layer formed on the porous substrate contains (1) a binder resin, (2) zinc oxide particles, and (3) one or more heat-resistant filler selected from the group consisting of a metal hydroxide and a metal oxide other than zinc oxide, and a content of the zinc oxide particles is 2% by mass or more and less than 100% by mass with respect to a total content of the zinc oxide particles and the heat-resistant filler.

The separator for a non-aqueous secondary battery of the first embodiment may further have another layer.

Conventionally, the non-aqueous secondary battery generally contains a filler in order to increase the heat resistance and strength of the battery. Particularly, one or more heat-resistant filler selected from the group consisting of a metal hydroxide and a metal oxide other than the zinc oxide react with an electrolyte in a layer impregnated with an electrolyte solution, thereby deteriorating the liquid stability, which may contribute to the generation of gas by inducing the decomposition of the electrolyte solution and the electrolyte.

In view of the above circumstances, regarding the separator for a non-aqueous secondary battery of the first embodiment, the heat-resistant porous layer being in contact with an electrode is formed with the composition containing a specific filler at a specific ratio in addition to the binder resin. Specifically, the heat-resistant porous layer in the first embodiment is formed so that one or more heat-resistant filler selected from the group consisting of a metal hydroxide and a metal oxide other than zinc oxide is used together with zinc oxide particles, and the content ratio of the zinc oxide particles satisfies a specific range. This suppresses the generation of gas due to the decomposition of the electrolyte solution and the electrolyte induced by a metal hydroxide and a metal oxide other than zinc oxide, and suppresses swelling (battery deformation) due to the generation of gas. Further, the separator for a non-aqueous secondary battery of the first embodiment is excellent in heat resistance because of containing zinc oxide particles and a heat-resistant filler.

Hereinafter, the separator for a non-aqueous secondary battery of the first embodiment will be explained in detail.

[Porous Substrate]

The separator for a non-aqueous secondary battery of the first embodiment includes a porous substrate. In this regard, the separator for a non-aqueous secondary battery of the second embodiment also includes a porous substrate. Hereinafter, the porous substrate of the first embodiment and the porous substrate of the second embodiment will be collectively referred to as “porous substrate” and explained. The porous substrate means a substrate having holes or voids therein.

The porous substrate is, for example, a micro-porous membrane, a porous sheet made of a fibrous material such as a non-woven fabric or paper or a composite porous sheet in which one or more other porous layers are layered on a micro-porous membrane or a porous sheet. Here, the micro-porous membrane means a membrane which has many micro-pores therein and has a structure in which micro-pores are mutually connected so that a gas or liquid can pass from one surface to the other.

The material of the porous substrate is preferably a material having electrical insulation and may be either an organic material and/or an inorganic material.

The porous substrate preferably contains a thermoplastic resin from the viewpoint of applying a shutdown function to the porous substrate. The term “shutdown function” refers to the following function: in a case in which the battery temperature increases, the material melts and blocks the pores of the porous substrate, thereby blocking the movement of ions to suppress the thermal runaway of the battery. The thermoplastic resin is preferably a thermoplastic resin having a melting point of less than 200° C. and particularly preferably polyolefin.

The porous substrate is preferably a micro-porous membrane containing polyolefin (referred herein as to “micro-porous polyolefin membrane”).

As the micro-porous polyolefin membrane, a micro-porous polyolefin membrane having sufficient dynamic characteristics and ion permeability may be selected from micro-porous polyolefin membranes applied to the conventional separator for a non-aqueous secondary battery.

From the viewpoint of exerting a shutdown function, the micro-porous polyolefin membrane preferably contains polyethylene (i.e., a micro-porous polyethylene membrane) and the content of polyethylene is preferably 95% by mass or more.

The micro-porous polyolefin membrane is preferably a micro-porous polyolefin membrane containing polyethylene and polypropylene from the viewpoint of applying heat resistance at a level in which the membrane is not easily broken when being exposed to high temperatures. The micro-porous polyolefin membrane is, for example, a micro-porous membrane existing polyethylene and polypropylene in one layer. The micro-porous membrane preferably contains 95% by mass or more of polyethylene and 5% by mass or less of polypropylene from the viewpoint of achieving both the shutdown function and heat resistance. Further, from the viewpoint of achieving both the shutdown function and heat resistance, the micro-porous polyolefin membrane preferably has a two or more layered structure, and also preferably has a structure in which at least one layer contains polyethylene and at least one layer contains polypropylene.

The weight-average molecular weight of polyolefin contained in the micro-porous polyolefin membrane is preferably from 100,000 to 5,000,000. When the weight-average molecular weight is 100,000 or more, it is possible to ensure favorable dynamic characteristics. Meanwhile, when the weight-average molecular weight is 5,000,000 or less, shutdown characteristics are favorable and it is easy to mold a membrane.

The micro-porous polyolefin membrane can be produced, for example, by the following method. Namely, it is a method of forming a micro-porous membrane including: extruding a molten polyolefin resin from a T-die to form the resin into a sheet, crystallizing the sheet; stretching the resulting sheet; and heat-treating the sheet or a method of forming a micro-porous membrane including: extruding a polyolefin resin molten together with a plasticizer such as liquid paraffin from a T-die to form the resin into a sheet; cooling the extruded resin; stretching the resin; extracting the plasticizer; and heat-treating the resulting resin.

Examples of the porous sheet made of a fibrous material include non-woven fabrics and paper, which are made of fibrous materials such as polyester (e.g., polyethylene terephthalate); polyolefin (e.g., polyethylene and polypropylene); and a heat resistant resin (e.g., aromatic polyamide, polyimide, polyether sulfone, polysulfone, polyether ketone and polyether imide).

The heat resistant resin means a polymer having a melting point of 200° C. or more or a polymer not having a melting point but having a decomposition temperature of 200° C. or more.

The composite porous sheet is, for example, a sheet in which a functional layer is layered on a porous sheet formed of a micro-porous membrane or fibrous material. The composite porous sheet is preferred in terms of the fact that another function can be added by the functional layer. For example, from the viewpoint of giving heat resistance, the functional layer is preferably a porous layer containing a heat resistant resin or a porous layer containing a heat resistant resin and an inorganic filler. Examples of the heat resistant resin include one or two or more kinds of the heat resistant resins selected from aromatic polyamide, polyimide, polyether sulfone, polysulfone, polyether ketone, or polyether imide. Examples of the inorganic filler include metal oxides such as aluminum oxide and metal hydroxides such as magnesium hydroxide. Examples of the method of forming the functional layer on the micro-porous membrane or the porous sheet include a method of applying the functional layer to the micro-porous membrane or the porous sheet, a method of bonding the functional layer to the micro-porous membrane or the porous sheet using an adhesive agent, and a method of bonding the functional layer to the micro-porous membrane or the porous sheet by thermal compression.

[Characteristics of Porous Substrate]

The average pore size of the porous substrate of the present disclosure is preferably in a range of from 20 nm to 100 nm. When the average pore diameter of the porous substrate is 20 nm or more, ions easily move and thus it is easy to obtain favorable battery performance. From this viewpoint, the average pore size of the porous substrate is preferably 30 nm or more and still more preferably 40 nm or more. Meanwhile, when the average pore diameter of the porous substrate is 100 nm or less, the peeling strength between the porous substrate and the porous layer is improved, and thus a favorable shutdown function can be exerted. From this viewpoint, the average pore size of the porous substrate is preferably 90 nm or less and still more preferably 80 nm or less.

The average pore diameter of the porous substrate is a value measured using a perm porometer, and the value may be measured, for example, using the perm porometer (CFP-1500-A manufactured by PMI) in accordance with ASTM E1294-89.

The thickness of the porous substrate is preferably in a range of from 3 μm to 25 μm from the viewpoint of obtaining favorable dynamic properties and internal resistance. Particularly, the thickness of the porous substrate is more preferably in a range of from 5 μm to 20 μm.

The Gurley value of the porous substrate (JIS P8117: 2009) is preferably in a range of from 50 sec/100 cc to 400 sec/100 cc from the viewpoint of suppressing the short circuit of the battery and obtaining sufficient ion permeability.

The porosity of the porous substrate is preferably in a range of from 20% to 60%/o from the viewpoint of obtaining an appropriate membrane resistance and a shutdown function.

The puncture strength of the porous substrate is preferably 200 g or more from the viewpoint of improving the production yield.

Preferably, the porous substrate is subjected to various kinds of surface treatments. The surface treatments are performed so that it is possible to improve the wettability with a coating liquid for forming the heat-resistant porous layer, which will be described later. Specific examples of the surface treatments include corona, plasma, flame, and ultraviolet irradiation treatments, and these treatments are performed in a range that does not deteriorate the property of the porous substrate.

[Heat-Resistant Porous Layer of First Embodiment]

The separator for a non-aqueous secondary battery of the first embodiment has a heat-resistant porous layer on a porous substrate. The heat-resistant porous layer is disposed on one or both surfaces of the porous substrate and is a porous layer containing (1) a binder resin, (2) zinc oxide particles, and (3) one or more heat-resistant filler selected from the group consisting of a metal hydroxide and a metal oxide other than zinc oxide.

The heat-resistant porous layer has many micro-pores therein and has a structure in which micro-pores are mutually connected so that a gas or liquid can pass from one surface to the other.

The heat-resistant porous layer may contain components other than a binder resin, zinc oxide particles, and one or more heat-resistant filler selected from the group consisting of a metal hydroxide and a metal oxide other than zinc oxide (e.g., other fillers).

The heat-resistant porous layer of the first embodiment may be disposed on only one surface or may be disposed on both surfaces of the porous substrate. In a case in which the heat-resistant porous layer is disposed on only one surface of the porous substrate, it is possible to reduce the thickness of the whole separator, thereby contributing to the improvement of the battery capacity. Further, the number of laminated layers is small, whereby favorable ion permeability is easily obtained. Meanwhile, in a case in which the heat-resistant porous layer is disposed on both surfaces of the porous substrate, the heat resistance of the separator is more excellent and the battery safety can be improved. Further, in a case in which the heat-resistant porous layer is disposed on both surfaces of the porous substrate, the separator is hardly curled.

(Binder Resin of First Embodiment)

The heat-resistant porous layer contains at least one binder resin.

The binder resin contained in the heat-resistant porous layer of the first embodiment is not particularly limited as long as it is a binder resin capable of bonding zinc oxide particles and particles containing a heat-resistant filler with each other. The binder resin is preferably a polymer having a functional group or an atomic group with polarity (a polar group such as a hydroxyl group, a carboxyl group, an amino group, an amide group, or a carbonyl group), and examples thereof include wholly aromatic polyamide, fluorine type resin, polyimide, polyamidoimide, polysulfone, polyketone, polyether sulfone, polyether ketone, polyether imide, and cellulose. The binder resins may be used singly, or in combination of two or more kinds thereof.

The binder resin is preferably a fluorine type resin or wholly aromatic polyamide from the viewpoint of being insoluble in the electrolyte solution and having excellent heat resistance.

Examples of the fluorine type resin include polyvinylidene fluoride type resins such as polyvinylidene fluoride and a polyvinylidene fluoride copolymer.

The wholly aromatic polyamide is preferably polymetaphenylene isophthalamide, i.e., meta-type wholly aromatic polyamide in view of easily forming a porous layer and having excellent oxidation-reduction resistance. For example, a small amount of an aliphatic component may be copolymerized with the wholly aromatic polyamide.

As the binder resin of the first embodiment, a particulate resin may be used. Examples of the particulate resin include particles containing resins such as polyvinylidene fluoride type resins, fluorine rubbers, and styrene-butadiene rubbers. The particulate resin is dispersed in a dispersion medium such as water, and can be used to produce a coating liquid.

A water soluble resin may be used as the binder resin of the first embodiment. The water soluble resin is, for example, a cellulose resin or polyvinyl alcohol. The water soluble resin is dispersed in, for example, water and can be used to produce a coating liquid.

The particulate resin and the water soluble resin are preferred in the case of performing the coagulation step during the dry production method.

—Polyvinylidene Fluoride Type Resin of First Embodiment—

The binder resin of the first embodiment is preferably a polyvinylidene fluoride type resin in terms of having excellent adhesion with an electrode. The polyvinylidene fluoride type resin is contained, whereby the battery strength (cell strength) is increased with an improvement in adhesion with the electrode. For example, in the case of forming a soft pack battery, the strength to be required is ensured and the quality stability is excellent.

Examples of the polyvinylidene fluoride type resin include a homopolymer of vinylidene fluoride (polyvinylidene fluoride), a copolymer of vinylidene fluoride and another copolymerizable monomer, (a polyvinylidene fluoride copolymer), and a mixture thereof.

Examples of the monomer copolymerizable with vinylidene fluoride include tetrafluoroethylene, hexafluoropropylene (HFP), trifluoroethylene, trichloroethylene, and vinyl fluoride, and one or two or more kinds thereof can be used.

Among the polyvinylidene fluoride type resins, a copolymer in which vinylidene fluoride and hexafluoropropylene are at least copolymerized is preferred from the viewpoint of adhesion with the electrode. Vinylidene fluoride and hexafluoropropylene are copolymerized, and a copolymer including the VDF unit derived from vinylidene fluoride (VDF) and the HFP unit derived from hexafluoropropylene (HFP) (VDF-HFP copolymer) can control the crystallinity and heat resistance of the resin in an appropriate range. Accordingly, it is possible to suppress the heat-resistant porous layer from flowing away during heat pressing when allowing the separator to adhere to the electrode.

The polyvinylidene fluoride type resin is preferably a VDF-HFP copolymer containing a VDF unit of from 93% by mol or more as a structural unit. In a case in which the VDF unit contained is 93% by mol or more, favorable dynamic properties and heat resistance can be ensured under the heat pressing conditions such as low temperatures.

The fibril diameter of the polyvinylidene fluoride type resin contained in the heat-resistant porous layer is preferably from 10 nm to 1000 nm from the viewpoint of cycle characteristics.

Generally, a battery including a separator having a polyvinylidene fluoride type resin-containing heat-resistant porous layer is produced by forming a laminated body including an electrode and a separator via a process of piling up and winding up the electrode and the separator or a process of alternately stacking the electrode and the separator, housing the laminated body in an outer case, and heat pressing (wet-heat pressing) the outer case in a state in which the electrolyte solution is injected. According to wet-heat pressing, the polyvinylidene fluoride type resin comes in contact with the electrolyte solution and heat pressed in a state in which the polyvinylidene fluoride type resin is swollen with the electrolyte solution. Consequently, the adhesion between the electrode and the separator becomes favorable and this is advantageous in terms of excellent charge/discharge characteristics. Meanwhile, with an increase in temperature during wet-heat pressing, the stability of liquid tends to decrease due to the effect of the heat-resistant filler, whereby the decomposition of the electrolyte solution and the electrolyte tends to be induced. However, zinc oxide particles are contained, thereby suppressing the generation of gas due to the decomposition of the electrolyte solution and the electrolyte and suppressing a battery swelling phenomenon.

There are two kinds of the adhesion by heat-pressing: the adhesion by wet-heat pressing in which the separator is adhered to the electrode after the separator is impregnated with the electrolyte solution, and the adhesion by dry-heat pressing in which the separator is temporarily adhered to the electrode before being impregnated with the electrolyte solution. The adhesion by wet-heat pressing and the adhesion by dry-heat pressing are easily influenced by the content of the HFP unit and the weight-average molecular weight of the VDF-HFP copolymer.

In order to improve the adhesion by wet-heat pressing, it is important to have an appropriate fluidity, i.e., an appropriate weight-average molecular weight. In order to impart flexibility to the resin and allow the resin to swell without dissolving the separator in the electrolyte solution, it is important that the ratio of the HFP unit is in an appropriate range.

Focusing on the copolymerization component of the VDF-HFP copolymer, from the viewpoint of improving the adhesion by wet-heat pressing at an appropriate temperature, the hexafluoropropylene (HFP) monomer unit is preferably in a range of from 1.0% by mol to 7.0% by mol with respect to a total amount of the vinylidene fluoride (VDF) monomer unit and the hexafluoropropylene (HFP) monomer unit.

Specifically, when the copolymerization ratio of the HFP unit in the VDF-HFP copolymer is 1.0% by mol or more, the copolymer is appropriately swollen when impregnated with the electrolyte solution. Thus, the adhesion by wet-heat pressing is easily improved. Meanwhile, when the copolymerization ratio of the HFP unit is 7.0% by mol or less, the copolymer hardly dissolves in the electrolyte solution and is preferably applied to the heat-resistant porous layer.

From the same viewpoint as described above, the content of the HFP unit in the VDF-HFP copolymer is preferably from 2.0% by mol to 6.0% by mol.

As the VDF-HFP copolymer, other copolymerization components copolymerizable with vinylidene fluoride may be contained, in addition to the copolymer composed of only the VDF and HFP units. Examples of the monomer copolymerizable with vinylidene fluoride, except for hexafluoropropylene, include tetrafluoroethylene, trifluoroethylene, trichloroethylene, chlorotrifluoroethylene, and vinyl fluoride, and one or two or more kinds thereof can be used.

The weight-average molecular weight (Mw) of the polyvinylidene fluoride type resin is preferably in a range of from 600,000 to 3,000,000. When the weight-average molecular weight is 600,000 or more, it is easy to obtain a heat-resistant porous layer having dynamic properties capable of bearing heat pressing when being adhered to the electrode and the adhesion between the electrode and the heat-resistant porous layer is improved. Particularly, the adhesion by wet-heat pressing becomes excellent. The weight-average molecular weight of the polyvinylidene fluoride type resin is more preferably 800,000 or more and still more preferably 1,000,000 or more from the same viewpoint as described above.

Meanwhile, when the weight-average molecular weight is 3,000,000 or less, the viscosity at the time of molding does not become too high and the moldability and crystal formation become favorable. Thus, it is easy to make the resin porous. Therefore, from the viewpoint of allowing the moldability and crystal formation to be favorable and improving the adhesion, the weight-average molecular weight of the polyvinylidene fluoride type resin is preferably 2,500,000 or less and more preferably 2,000,000 or less.

Note that the weight-average molecular weight (Mw) of the polyvinylidene fluoride type resin is measured by gel permeation chromatography (hereinafter, also referred to as “GPC”) under the following conditions and converted to polystyrene equivalents.

<Conditions>
GPC: GPC-900 (manufactured by JASCO Corporation)
Column: TSKgel Super AWM-H×2 (manufactured by TOSOH CORPORATION)
Mobile phase solvent: dimethylformamide (DMF)
Standard sample: mono-disperse polystyrene [manufactured by TOSOH CORPORATION]
Column temperature: 140° C.
Flow rate: 10 ml/min

The polyvinylidene fluoride type resin can be obtained by emulsion polymerization or suspension polymerization.

Further, the acid value of the polyvinylidene fluoride type resin is preferably in a range of from 3 mgKOH/g to 20 mgKOH/g.

The acid value can be controlled, for example, by introducing a carboxyl group into the polyvinylidene fluoride type resin. The introduction of the carboxyl group to the polyvinylidene fluoride type resin and the introduction amount thereof can be controlled by using a monomer having a carboxyl group (e.g., carboxylate ester, maleic acid, maleic anhydride) as the polymerization component of the VDF-HFP copolymer, i.e., the polyvinylidene fluoride type resin and adjusting the polymerization ratio of the monomer.

—Other Resins of First Embodiment—

The heat-resistant porous layer of the first embodiment may contain other resins other than the binder resin. Examples of other resins include fluorine rubbers, acrylic resins, styrene butadiene copolymers, and homopolymers or copolymers of vinyl nitrile compounds (acrylonitrile, methacrylonitrile, etc.), carboxymethylcellulose, hydroxyalkyl cellulose, polyvinyl alcohol, polyvinyl butyral, polyvinyl pyrrolidone, and polyether (polyethylene oxide, polypropylene oxide, etc.).

The total content of other resins in the heat-resistant porous layer is preferably 5% by mass or less, more preferably 3% by mass or less, and still more preferably 1% by mass or less with respect to the total amount of the resin contained in the heat-resistant porous layer. Particularly, the total content is preferably a detection limit or less.

(Zinc Oxide Particles of First Embodiment)

The heat-resistant porous layer of the first embodiment contains one or more heat-resistant filler selected from the group consisting of a metal hydroxide and a metal oxide other than zinc oxide; and zinc oxide particles. Zinc oxide particles are stable to the electrolyte solution and are electrochemically stable inorganic particles. Zinc oxide particles are selectively contained as the inorganic particles, thereby not only improving the sliding properties and heat resistance of the separator but also giving an effect of suppressing swelling (battery deformation) due to the generation of gas caused by the heat-resistant filler component. This is assumed that zinc oxide itself incorporates hydrogen fluoride generated in the battery and suppresses the decomposition of the electrolyte solution caused by hydrogen fluoride.

Zinc oxide particles of the first embodiment preferably have an average particle diameter of from 0.1 μm to 1 μm. When the average particle diameter is 0.1 μm or more, the effect of suppressing the generation of gas is excellent. Further, when the average particle diameter is 1 μm or less, it is easy to make the heat-resistant porous layer thinner. Furthermore, the particle diameter of zinc oxide has a large influence on the adhesion at the interface between the separator and the electrode. When the particle diameter of the zinc oxide is too small or too large, the adhesion decreases. Accordingly, the average particle diameter of zinc oxide particles is more preferably in a range of from 0.2 μm to 0.5 μm.

The average particle diameter is a value as measured using a laser diffraction particle size distribution measurement device and is measured, for example, using Master Sizer 2000 (manufactured by Sysmex Corporation). Specifically, in the volume particle size distribution, the median diameter (D50) of the dispersion obtained by mixing and dispersing zinc oxide particles, water (dispersion medium), and a non-ionic surfactant (Triton X-100; dispersant) is defined as an average particle diameter.

Zinc oxide of the first embodiment may have any shape and the shape may be, for example, spherical, scale-like, plate-shaped, hexagonal plate-shaped or needle-like. The particles preferably have a hexagonal plate-shaped shape from the viewpoint of suppressing an increase in the viscosity of the coating liquid. Zinc oxide particles are preferably in the form of primary particles free from aggregation.

Hexagonal plate-shaped particles of the first embodiment are characterized in that 50° or more of particles among 100 particles in a transmission electron microscope photograph satisfy all the following conditions (1) and (2); and have a hexagonal surface.

(1) The particles have a hexagonal surface:

(2)Lmin/Lmax≥0.7

(wherein Lmax indicates the length of the longest diagonal line among three diagonal lines in the hexagonal surface of the hexagonal plate-shaped particles, and

Lmin indicates the length of the shortest diagonal line among three diagonal lines in the hexagonal surface of the hexagonal plate-shaped particles.)

When Lmax is defined as a length of a diagonal line of a regular hexagon, Lmin/Lmax indicates a difference to the length of the diagonal line of the regular hexagon. As the value is close to 1, the difference to the regular hexagon is smaller, meanwhile, as the difference is close to 0, the difference is larger. Lmin/Lmax is 0.7 or more and is more preferably 0.9 or more.

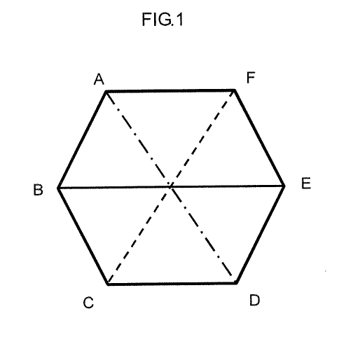

Note that, in the definition, three diagonal lines indicate a diagonal line AD obtained by connecting A and D, a diagonal line BE obtained by connecting B and E, and a diagonal line CF obtained by connecting C and F, respectively, in a case in which when one vertex of the hexagon in the hexagonal surface is represented by A, vertices are represented by B, C. D, E, and F sequentially from the vertex adjacent to A. Among the diagonal lines AD, BE, and CF, the length of the longest diagonal line is represented by Lmax, and the length of the shortest diagonal line is represented by Lmin. FIG. 1 illustrates a pattern diagram of each of these parameters.

Each of the parameter values was measured based on a transmission electron microscope photograph, and Lmax and Lmin were measured with a ruler.

It is desirable that the aspect ratio of the hexagonal plate-shaped particles of the first embodiment is preferably 2.5 or more and less than 100, more preferably 2.7 or more, and most preferably 3.0 or more.

The aspect ratio of the hexagonal plate-shaped particles of the first embodiment is a value determined under the condition where, in an image taken by a scanning electron microscope (SEM), regarding the particles in which the hexagonal surface of the hexagonal plate-shaped particles is facing front, a particle diameter (μm) defined by a unidirectional diameter (interval of two unidirectional parallel lines across the particles; the particles in which the hexagonal surface on the image is facing front are measured unidirectionally) as to 100 particles is measured and the average thereof is represented by L, meanwhile, regarding the particles in which the side surface of the hexagonal plate-shaped particles is facing front (the particles look like rectangular), the thickness (μm) (the length of the short side of a rectangle) as to 100 particles is measured and the average thereof is represented by T, a ratio of the values is represented by L/T.

In the heat-resistant porous layer, the content of the zinc oxide particles is in a range of 2% by mass or more and less than 100% by mass with respect to a total content of the zinc oxide particles and one or more heat-resistant filler selected from the group consisting of a metal hydroxide and a metal oxide other than zinc oxide. When the content of the zinc oxide particles is less than 2% by mass, the effect of suppressing the generation of gas due to the decomposition of the electrolyte solution and the electrolyte induced by the heat-resistant filler becomes insufficient. When the content of the zinc oxide particles is 2% by mass or more, the effect of suppressing the generation of gas can sufficiently be obtained, and the content is preferably 10% by mass or more and more preferably 20% by mass or more.

In the heat-resistant porous layer of the first embodiment, the total content of the zinc oxide particles and one or more heat-resistant filler selected from the group consisting of a metal hydroxide and a metal oxide other than zinc oxide is preferably from 30% by volume to 85% by volume with respect to the solid content of the heat-resistant porous layer.

When the total content of the zinc oxide particles and the heat-resistant filler is 30% by volume or more, the heat resistance becomes more excellent. From the same reason as described above, the content of the zinc oxide particles and the heat-resistant filler is more preferably 35% by volume or more and still more preferably 40% by volume or more.

Further, when the content of the zinc oxide particles and the heat-resistant filler is 85% by volume or less, the particles have excellent handling properties without dropping the particles or the fillers. From the same reason as described above, the content of the zinc oxide particles and the heat-resistant filler is more preferably 75% by volume or less, and still more preferably 70% by volume or less.

(Heat-Resistant Filler of First Embodiment)

The heat-resistant porous layer of the first embodiment contains one or more heat-resistant filler selected from the group consisting of a metal hydroxide and a metal oxide other than zinc oxide so that a heat-resistant effect is obtained and the heat resistance of the separator is improved. Meanwhile, it is common that the heat-resistant fillers react with an electrolyte in a layer impregnated with an electrolyte solution, thereby deteriorating the liquid stability, which may contribute to the generation of gas by inducing the decomposition of the electrolyte solution and the electrolyte. In the first embodiment, in addition to the heat-resistant fillers, a predetermined amount of zinc oxide particles is used together. This suppresses the generation of gas due to the decomposition of the electrolyte solution and the electrolyte and suppresses swelling (battery deformation) due to the generation of gas.

Examples of the metal oxide other than zinc oxide among the heat-resistant fillers of the first embodiment include alumina, titania, magnesia, silica, and zirconia. Examples of the metal hydroxide include aluminum hydroxide, magnesium hydroxide, calcium hydroxide, chromium hydroxide, zirconium hydroxide, cerium hydroxide, nickel hydroxide, and hydroxylation boron.

Among the heat-resistant fillers, one or more heat-resistant filler selected from the group consisting of magnesium hydroxide, aluminum hydroxide, aluminum oxide, boehmite (alumina monohydrate), and magnesium oxide are preferred from the viewpoint of the fact that the effect of improving the heat resistance and strength of the battery is contemplated at low cost.

The average particle diameter of the heat-resistant filler of the first embodiment is preferably from 0.01 μm to 10 μm. Regarding the average particle diameter, the lower limit is preferably 0.1 μm or more and the upper limit is more preferably 5 μm or less.

A particle size distribution d90-d10 of the heat-resistant filler of the first embodiment preferably satisfies 0.1 μm<d90-d10<3 μm.

Note that the average particle diameter and particle size distribution of the heat-resistant filler are values measured similarly to the average particle diameter and particle size distribution of zinc oxide particles.

(Other Fillers of First Embodiment)

The heat-resistant porous layer of the first embodiment may further contain other fillers, in addition to the zinc oxide particles and the heat-resistant filler, in a range that does not deteriorate the effect of the invention. Other fillers may be either inorganic fillers composed of inorganic materials or organic fillers composed of organic materials. The heat-resistant porous layer appropriately contains other fillers so that it is possible to control the sliding properties and heat resistance of the separator.

In the case of using other fillers together, it is preferable to control the content, the average particle diameter, and the particle size distribution in a range that does not deteriorate the effect of the invention.

Examples of the other inorganic fillers include carbonates such as calcium carbonate and magnesium carbonate, sulfates such as barium sulfate and calcium sulfate, and clay minerals such as calcium silicate and talc.

Examples of the organic fillers include crosslinked acrylic resins such as crosslinked polymethyl methacrylate, and crosslinked polystyrene, and a preferable example thereof includes crosslinked polymethyl methacrylate.

Other fillers may be used singly, or in combination of two or more kinds thereof. Further, a filler having a surface modified with a silane coupling agent or the like may be used.

The content of other fillers is preferably less than 5% by mass with respect to the total amount of zinc oxide particles and the heat-resistant filler from the viewpoint of more effectively suppressing the generation of gas due to the decomposition of the electrolyte solution and the electrolyte.

Further, the total amount of zinc oxide particles, the heat-resistant filler, and other fillers in the heat-resistant porous layer is preferably 30% by mass or more and more preferably 50% by mass or more with respect to the solid content of the heat-resistant porous layer, from the viewpoint of improving the heat resistance.

(Other Components of First Embodiment)

If necessary, the heat-resistant porous layer of the first embodiment may contain a dispersant such as a surfactant or another additive as other component in a range that does not deteriorate the effect of the invention. The heat-resistant porous layer contains the dispersant so that it is possible to improve the dispersibility, coating properties, and storage stability.

The heat-resistant porous layer may contain any of various additives such as a wetting agent that improves the affinity with the porous substrate, an antifoaming agent that suppresses incorporation of air into the coating liquid or a pH adjusting agent including an acid or an alkali. The additive may remain as long as it is electrochemically stable in the use range of the lithium ion secondary battery and does not inhibit the reaction in the battery.

[Various Characteristics of Heat-Resistant Porous Layer of First Embodiment]

In the separator for a non-aqueous secondary battery of the first embodiment, in a case in which the heat-resistant porous layer is formed by coating, the coating amount as the total of both surfaces of the porous substrate is preferably from 1.0 g/m² to 10.0 g/m².

In a case in which the heat-resistant porous layer is formed on one surface of the porous substrate, the term “the total of both surfaces of the porous substrate” means the coating amount on one surface. Meanwhile, in a case in which the heat-resistant porous layer is formed on both surfaces of the porous substrate, the term means the total of the coating amount on both surfaces.

It is preferable that the coating amount is 1.0 g/m² or more in terms of the fact that the heat resistance is further improved. Meanwhile, it is preferable that the coating amount is 10.0 g/m² or less in terms of the fact that the ion permeability becomes more favorable and the load characteristics of the battery are further improved. The coating amount as the total of both surfaces of the porous substrate is more preferably from 1.5 g/m² to 8.0 g/m².

Further, the coating amount on one surface of the porous substrate is preferably from 0.5 g/m² to 5.0 g/m² and more preferably from 0.75 g/m² to 4.0 g/m².

In a case in which the heat-resistant porous layer of the first embodiment is formed on both surfaces of the porous substrate, a difference between the coating amount on one surface and the coating amount on the other surface is preferably 20% by mass or less with respect to the total coating amount on both surfaces. When the difference between the coating amounts is 20% by mass or less, the separator is hardly curled, thereby obtaining excellent handling properties.

The thickness of the heat-resistant porous layer of the first embodiment on one surface of the porous substrate is preferably from 0.5 μm to 6 μm. It is preferable that the thickness of the heat-resistant porous layer is 0.5 μm or more from the viewpoint of ensuring sufficient heat resistance. From this viewpoint, the thickness of the heat-resistant porous layer of the first embodiment on one surface of the porous substrate is preferably 1 μm or more. Meanwhile, when the thickness of the heat-resistant porous layer is 6 μm or less, the ion permeability becomes more favorable and the load characteristics of the battery becomes more excellent. From this viewpoint, the thickness of the heat-resistant porous layer on one surface of the porous substrate is more preferably 5.5 μm or less and still more preferably 5.0 μm or less.

The porosity of the heat-resistant porous layer of the first embodiment is preferably in a range of from 30% to 80%. When the porosity is 80% or less, it is easy to ensure the dynamic properties capable of bearing heat pressing. Meanwhile, when the porosity is 30% or more, the ion permeability becomes more favorable.

The porosity (ε) is a value calculated by the following formula:

ε={1−Ws/(ds·t)}×100

In the formula, ε represents porosity (%), Ws represents a basis weight (g/m2), ds represents a true density (g/cm3), and t represents a membrane thickness (μm).

In the case of using a polyvinylidene fluoride type resin as the binder resin, the average pore diameter of the heat-resistant porous layer of the first embodiment is preferably in a range of from 10 nm to 200 nm. When the average pore diameter is 200 nm or less, pore non-uniformity is reduced, adhesion points are relatively uniformly scattered, and thus the adhesion is further improved. Further, when the average pore diameter is 200 nm or less, the uniformity in movement of ions is high, and the cycle characteristics and load characteristics are further improved. Meanwhile, when the average pore diameter is 10 nm or more, the following phenomenon hardly occurs: in a case in which the heat-resistant porous layer is impregnated with the electrolyte solution, the resin constituting the heat-resistant porous layer is swollen and the pores are blocked, whereby the ion permeability is inhibited.

Note that it is assumed that all the pores are cylindrical using a pore surface area S of the heat-resistant porous layer composed of the polyvinylidene fluoride type resin which is calculated from the adsorption amount of nitrogen gas and a pore volume V of the heat-resistant porous layer which is calculated from the porosity, and the average pore diameter (diameter, unit: nm) of the heat-resistant porous layer is calculated by the following formula:

d=4·V/S

In the formula, d represents an average pore diameter (nm) of the heat-resistant porous layer, V represents a pore volume per m² of the heat-resistant porous layer, and S represents a pore surface area per m² of the heat-resistant porous layer.

The pore surface area S per m² of the heat-resistant porous layer is determined by the following method.

The specific surface area (m²/g) of the porous substrate and the specific surface area (m²/g) of a composite membrane in which the porous substrate and the heat-resistant porous layer are layered are measured using the BET equation by the nitrogen gas adsorption method. Each of the pore surface areas per m² is calculated by multiplying each of the specific surface areas by each of the basis weights (g/m²). Then, the pore surface area S per m² of the heat-resistant porous layers is calculated by subtracting the pore surface area per m² of the porous substrate from the pore surface area per m² of the separator.

[Various Characteristics of Separator for a Non-Aqueous Secondary Battery of First Embodiment]

The porosity of the separator for a non-aqueous secondary battery of the first embodiment is preferably in a range of from 30% to 60% from the viewpoint of allowing the dynamic properties of the separator to be favorable.

The Gurley value of the separator for a non-aqueous secondary battery of the first embodiment in accordance with the Japanese Industrial Standards (JIS P8117: 2009) is preferably in a range of from 50 sec/100 cc to 800 sec/100 cc in terms of an excellent balance between mechanical strength and membrane resistance.

The separator for a non-aqueous secondary battery of the first embodiment is preferably a structure made porous from the viewpoint of ion permeability. Specifically, a value obtained by subtracting the Gurley value of the porous substrate from the Gurley value of the separator for a non-aqueous secondary battery having the heat-resistant porous layer formed thereon (hereinafter referred to as “Gurley difference”) is preferably 300 sec/100 cc or less, more preferably 150 sec/100 cc or less, and more preferably 100 sec/100 cc or less. The Gurley difference is preferably 300 sec/100 cc or less so that the heat-resistant porous layer is not excessively densified, ion permeability is favorably maintained, and excellent battery characteristics can be obtained. Meanwhile, the Gurley difference is preferably 0 sec/100 cc or more. In order to improve the adhesion force between the heat-resistant porous layer and the porous substrate, the Gurley difference is preferably 10 sec/100 cc or more.

The membrane resistance of the separator for a non-aqueous secondary battery of the first embodiment is preferably in a range of from 1 ohm cm² to 10 ohm cm² from the viewpoint of the load characteristics of the battery. The membrane resistance is a resistance value when impregnating the separator with the electrolyte solution and is measured by the alternating current method. The membrane resistance value varies depending on the kind and temperature of the electrolyte solution, and the membrane resistance value is a value measured at 20° C. using a mixed solvent of 1 M LiBF₄-propylene carbonate/ethylene carbonate (mass ratio: 1/1) as the electrolyte solution.

The tortuosity ratio of the separator for a non-aqueous secondary battery of the first embodiment is preferably in a range of from 1.5 to 2.5 from the viewpoint of ion permeability.

The amount of water contained in the separator for a non-aqueous secondary battery of the first embodiment is preferably 1000 ppm or less. As the amount of water of the separator for a non-aqueous secondary battery is low, the reaction between the electrolyte solution and the water is suppressed in a case in which the battery is formed, and the generation of gas in the battery can be suppressed more effectively. Thus, the cycle characteristics of the battery are further improved. From such a viewpoint, the amount of water contained in the separator for a non-aqueous secondary battery is more preferably 800 ppm or less and still more preferably 500 ppm or less.

The membrane thickness of the separator for a non-aqueous secondary battery of the first embodiment is preferably 30 μm or less and more preferably 25 μm or less from the viewpoint of the energy density and output characteristics of the battery.

The puncture strength of the separator for a non-aqueous secondary battery of the first embodiment is preferably in a range of from 250 g to 1000 g and more preferably in a range of from 300 g to 600 g.

[Method of Producing Separator for a Non-Aqueous Secondary Battery of First Embodiment]

The separator for a non-aqueous secondary battery of the first embodiment is produced, for example, by a method of coating a porous substrate with a coating liquid containing a binder resin, zinc oxide particles, and a heat-resistant filler to form a coating layer; and solidifying the resin of the coating layer to integrally form a heat-resistant porous layer on the porous substrate. Specifically, the heat-resistant porous layer containing a binder resin can be formed, for example, by the following wet coating method.

The wet coating method is a method of forming a heat-resistant porous layer on a porous substrate, including (i) dissolving a binder resin in an appropriate solvent and dispersing zinc oxide particles and a heat-resistant filler to prepare a coating liquid; (ii) applying the coating liquid to the porous substrate; (iii) solidifying the binder resin while inducing phase separation by immersing the porous substrate in an appropriate coagulation liquid; and performing (iv) washing with water and (v) drying. Details of the wet coating method suitable for the invention will be described below.

As a solvent used to prepare the coating liquid which dissolves the binder resin in order to disperse the zinc oxide particles and the heat-resistant filler (hereinafter also referred to as “good solvent”), a polar amide solvent such as N-methyl pyrrolidone, dimethylacetamide, and dimethylformamide is preferably used.

From the viewpoint of forming a favorable porous structure, it is preferable to add a phase separation agent for inducing phase separation in addition to a good solvent. Examples of the phase separation agent include water, methanol, ethanol, propyl alcohol, butyl alcohol, butanediol, ethylene glycol, propylene glycol, and tripropylene glycol. The phase separation agent is preferably added in a range of ensuring an appropriate viscosity in coating.

From the viewpoint of forming a favorable porous structure, the solvent is preferably a mixed solvent containing 60% by mass or more of the good solvent and 40% by mass or less of the phase separation agent.

The concentration of the resin in the coating liquid is preferably from 1% by mass to 20% by mass from the viewpoint of forming a favorable porous structure with respect to the total mass of the coating liquid. In the case of allowing the heat-resistant porous layer to contain other components, the components may be mixed with or dissolved in the coating liquid.

It is common that the coagulation liquid is composed of the good solvent and the phase separation agent, which are used to prepare the coating liquid, and water. It is preferable that the mixing ratio of the good solvent and the phase separation agent is adjusted to the mixing ratio of the mixed solvent used to dissolve the resin in production aspects. The concentration of water is appropriately from 40% by mass to 90% by mass from the viewpoint of the formation and productivity of the porous structure.

In order to coat the porous substrate of the first embodiment with the coating liquid, a conventional coating system such as a mayer bar, a die coater, a reverse roll coater or a gravure coater may be applied. In a case in which the heat-resistant porous layer is formed on both surfaces of the porous substrate, it is preferable to simultaneously coat both surfaces of the substrate with the coating solution at the same time from the viewpoint of productivity.

Besides the wet coating method as described above, a dry coating method can be used to produce the heat-resistant porous layer of the first embodiment. The dry coating method is, for example, a method including: coating a porous substrate with a coating liquid containing a binder resin, zinc oxide particles, and a heat-resistant filler; drying the coating layer for volatilization removal of the solvent; and forming a porous layer. In this regard, in the case of the dry coating method, the layer tends to be densified, compared to the case of the wet coating method. Accordingly, the wet coating method is more preferred in terms of the fact that a favorable porous structure can be obtained.

<Separator for a Non-Aqueous Secondary Battery of Second Embodiment>

The separator for a non-aqueous secondary battery of the second embodiment includes at least a porous substrate and a heat-resistant porous layer that is provided on one side or both sides of the porous substrate. The heat-resistant porous layer formed on the porous substrate contains a binder resin and hexagonal plate-shaped zinc oxide particles.

The separator for a non-aqueous secondary battery of the second embodiment may further have another layer.

Conventionally, the separator for a non-aqueous secondary battery has a heat-resistant porous layer containing a filler and a binder resin formed thereon in order to increase the heat resistance and strength of the battery. However, in the case of a coating liquid containing a filler and a binder resin, the temporal stability is reduced, and it is difficult to form a uniform heat-resistant porous layer in some cases.

In view of the above circumstances, regarding the separator for a non-aqueous secondary battery of the second embodiment, the heat-resistant porous layer is formed with the composition containing a specific filler in addition to the binder resin. Specifically, the heat-resistant porous layer in the second embodiment contains a hexagonal plate-shaped zinc oxide as the filler. Thus, the temporal stability of the viscosity of the coating liquid is improved, whereby fluctuation in the membrane thickness of the heat-resistant porous layer is reduced, as a result of which a separator for a non-aqueous secondary battery having a favorable appearance can be obtained.

Hereinafter, the separator for a non-aqueous secondary battery of the second embodiment will be explained in detail.

[Porous Substrate]

The separator for a non-aqueous secondary battery of the second embodiment includes a porous substrate. As the porous substrate in the separator for a non-aqueous secondary battery of the second embodiment, the porous substrate explained in the separator for a non-aqueous secondary battery of the first embodiment may be applied, and the preferable range and characteristics are the same as those described therein.

[Heat-Resistant Porous Layer of Second Embodiment]

The separator for a non-aqueous secondary battery of the second embodiment includes a heat-resistant porous layer on the porous substrate. The heat-resistant porous layer is provided on one side or both sides of the porous substrate and is a porous layer containing a binder resin and hexagonal plate-shaped zinc oxide particles.

The heat-resistant porous layer has many micro-pores therein and has a structure in which micro-pores are mutually connected so that a gas or liquid can pass from one surface to the other.

The heat-resistant porous layer may contain components other than the binder resin and the hexagonal plate-shaped zinc oxide particles (e.g., dispersants).

The configuration of the heat-resistant porous layer of the second embodiment with respect to the porous substrate may be the same as those explained in the first embodiment so that the repetitive explanation herein is omitted.

(Binder Resin of Second Embodiment)

The heat-resistant porous layer contains at least one binder resin.

The binder resin contained in the heat-resistant porous layer of the second embodiment is not particularly limited as long as it is a binder resin capable of bonding hexagonal plate-shaped zinc oxide particles with each other. The binder resin of the second embodiment may be the same as those explained in the first embodiment so that the repetitive explanation herein is omitted.

—Other Resins of Second Embodiment—

The heat-resistant porous layer of the second embodiment may contain other resins other than the binder resin. The other resins of the second embodiment may be the same as those explained in the first embodiment so that the repetitive explanation herein is omitted.

(Hexagonal Plate-Shaped Zinc Oxide of Second Embodiment)

The heat-resistant porous layer of the second embodiment contains a binder resin and hexagonal plate-shaped zinc oxide particles. Thus, the hexagonal plate-shaped zinc oxide particles are used, the temporal stability of the viscosity of the coating liquid is improved, whereby fluctuation in the membrane thickness of the heat-resistant porous layer is reduced, as a result of which a separator for a non-aqueous secondary battery having a favorable appearance can be obtained.

It is assumed that the zinc oxide incorporates hydrogen fluoride generated in the battery and suppresses the decomposition of the electrolyte solution and the electrolyte caused by hydrogen fluoride. In the case of using the zinc oxide, the generation of gas is suppressed, whereby swelling or deformation of a battery itself when produced can be suppressed.

The zinc oxide particles of the second embodiment preferably have an average particle diameter of from 0.1 μm to 1 μm. When the average particle diameter is 0.1 μm or more, the effect of suppressing the generation of gas is excellent. Further, when the average particle diameter is 1 μm or less, it is easy to make the heat-resistant porous layer thinner. Furthermore, the specific gravity of the zinc oxide is generally heavy, and as the particle diameter is larger, the zinc oxide tends to precipitate. Accordingly, the average particle diameter of the zinc oxide particles is more preferably in a range of from 0.1 upm to 0.5 μm.

The measurement of the average particle diameter is the same as those explained in the first embodiment so that the repetitive explanation herein is omitted.

The shape of the zinc oxide particles of the second embodiment is required to be hexagonal plate-shaped. Regarding the hexagonal plate-shaped zinc oxide particles, the primary particles have a shape close to the regular hexagon and have little aggregation and thus can be preferably used as a powder for forming a separator porous layer.

The definition and aspect ratio of the hexagonal plate-shaped zinc oxide particles of the second embodiment may be the same as the definition and aspect ratio of the hexagonal plate-shaped metal oxide particles of the first embodiment so that the repetitive explanation herein is omitted.

The content of hexagonal plate-shaped zinc oxide particles in the heat-resistant porous layer of the second embodiment is preferably from 30% by volume to 85% by volume with respect to the solid content of the heat-resistant porous layer.

When the content of hexagonal plate-shaped zinc oxide particles is 30% by volume or more, the resistance becomes more excellent. From the same reason as described above, the content of the hexagonal plate-shaped zinc oxide particles is more preferably 35% by volume or more and still more preferably 40% by volume or more.

Further, when the content of the hexagonal plate-shaped zinc oxide particles is 85% by volume or less, the particles have excellent handling properties without dropping the particles or the fillers. From the same reason as described above, the content of the hexagonal plate-shaped zinc oxide particles is more preferably 75% by volume or less and still more preferably 70% by volume or less.

(Other Fillers of Second Embodiment)

The heat-resistant porous layer of the second embodiment may further contain other fillers, in addition to the hexagonal plate-shaped zinc oxide particles, in a range that does not deteriorate the effect of the invention. Other fillers may be either inorganic fillers composed of inorganic materials or organic fillers composed of organic materials. The heat-resistant porous layer appropriately contains other fillers so that it is possible to control the sliding properties and heat resistance of the separator.

In the case of using other fillers together, it is preferable to control the content, the average particle diameter, and the particle size distribution in a range that does not deteriorate the effect of the invention.

Example of the other inorganic fillers include metal oxides such as alumina, titania, magnesia, silica, and zirconia; metal hydroxides such as aluminum hydroxide, magnesium hydroxide, calcium hydroxide, chromium hydroxide, zirconium hydroxide, cerium hydroxide, nickel hydroxide, and hydroxylation boron; carbonates such as calcium carbonate and magnesium carbonate; sulfates such as barium sulfate and calcium sulfate; and clay minerals such as calcium silicate and talc.

Examples of the organic fillers include crosslinked acrylic resins such as crosslinked polymethyl methacrylate, and crosslinked polystyrene, and a preferable example thereof includes crosslinked polymethyl methacrylate.

Other fillers may be used singly, or in combination of two or more kinds thereof. Further, a filler having a surface modified with a silane coupling agent or the like may be used.

In a case in which the heat-resistant porous layer of the second embodiment contains other fillers other than the hexagonal plate-shaped zinc oxide particles, the content of the hexagonal plate-shaped zinc oxide particles is preferably 2% by mass or more and less than 100% by mass with respect to the total content of the hexagonal plate-shaped zinc oxide particles and the other fillers. When the mass ratio of the content of the hexagonal plate-shaped zinc oxide particles is 2% by mass or more, an increase in the viscosity ratio of the coating liquid is sufficiently suppressed, and a separator having little fluctuation in the membrane thickness and a favorable appearance can be obtained. From the same reason as described above, the content of the hexagonal plate-shaped zinc oxide particles is preferably 10% by mass or more and more preferably 20% by mass or more.

(Other Components of Second Embodiment)

If necessary, the heat-resistant porous layer of the second embodiment may contain other components in a range that do not deteriorate the effect of the invention. The other components of the second embodiment may be the same as the other components explained in the first embodiment so that the repetitive explanation herein is omitted.

[Various Characteristics of Heat-Resistant Porous Layer of Second Embodiment]

In the separator for a non-aqueous secondary battery of the second embodiment, the various characteristics of the heat-resistant porous layer of the second embodiment may be the same as the various characteristics of the heat-resistant porous layer of the first embodiment so that the repetitive explanation herein is omitted.

[Various Characteristics of Separator for a Non-Aqueous Secondary Battery of Second Embodiment]

The various characteristics of the separator for a non-aqueous secondary battery of the second embodiment may be the same as the various characteristics of the separator for a non-aqueous secondary battery of the first embodiment so that the repetitive explanation herein is omitted.

[Method of Producing Separator for a Non-Aqueous Secondary Battery of Second Embodiment]

The non-aqueous electrolyte battery separator of the second embodiment is produced, for example, by a method of coating a porous substrate with a coating liquid containing a binder resin and hexagonal plate-shaped zinc oxide particles to form a coating layer; and solidifying the resin of the coating layer to integrally form a heat-resistant porous layer on the porous substrate. Specifically, the heat-resistant porous layer containing a binder resin can be formed, for example, by the following wet coating method.

The wet coating method is a method of forming a heat-resistant porous layer on a porous substrate, including (i) dissolving a binder resin in an appropriate solvent and dispersing hexagonal plate-shaped zinc oxide particles to prepare a coating liquid; (ii) applying the coating liquid to the porous substrate; (iii) solidifying the binder resin while inducing phase separation by immersing the porous substrate in an appropriate coagulation liquid; and performing (iv) washing with water and (v) drying. Details of the wet coating method suitable for the second embodiment may be the same as those explained in the first embodiment so that the repetitive explanation herein is omitted. Meanwhile, the solvent used to prepare the coating liquid which dissolves the binder resin in order to disperse the hexagonal plate-shaped zinc oxide particles (hereinafter also referred to as “good solvent”) may be the same as the good solvent of the first embodiment.

<Non-Aqueous Secondary Battery>

The non-aqueous secondary battery of the present disclosure includes the separator for a non-aqueous secondary battery of the first or second embodiment. Specifically, the non-aqueous secondary battery includes a positive electrode, a negative electrode, and the separator for a non-aqueous secondary battery according to the first or second embodiment disposed between the positive electrode and the negative electrode, wherein an electromotive force is obtained by lithium doping and dedoping. In this regard, the separator for a non-aqueous secondary battery in the non-aqueous secondary battery may be a separator for a non-aqueous secondary battery belonging to both the first and second embodiments.

In the non-aqueous secondary battery of the present disclosure, the separator is disposed between the positive and negative electrodes, and these battery elements are housed in an outer case together with the electrolyte solution. As the non-aqueous secondary battery, a lithium ion secondary battery is preferred.

Note that the term “doping” means absorption, support, adhesion, or insertion and means a phenomenon in which lithium ions enter an active material of an electrode such as a positive electrode.

The positive electrode may have a structure in which an active material layer containing a positive electrode active material and a binder resin is formed on a current collector. The active material layer may also contain a conductive auxiliary agent.

The positive electrode active material is, for example, a lithium containing transition metal oxide and specific examples thereof include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂, LiAl_{1/4}Ni_{3/4}O₂.

Examples of the binder resin include polyvinylidene fluoride type resins.

Examples of the conductive auxiliary agent include carbon materials such as acetylene black, ketjen black, and graphite powder.

Examples of the current collector include aluminum foil, titanium foil, and stainless steel foil which have a thickness of from 5 μm to 20 μm.

In a case in which the heat-resistant porous layer of the separator is disposed at the positive electrode side in the non-aqueous secondary battery, the heat-resistant porous layer is excellent in oxidation resistance, it is easy to apply a positive electrode active material which is operable at a high voltage of 4.2 V or more, such as LiMn_{1/2}Ni_{1/2}O₂ or LiCo_{1/3}Mn_{1/3}Ni_{1/3}O₂, and thus this is advantageous.

The negative electrode may have a structure in which an active material layer containing a negative electrode active material and a binder resin is formed on a current collector. The active material layer may also contain a conductive auxiliary agent.

The negative electrode active material is, for example, a material capable of electrochemically inserting lithium and examples thereof include carbon materials; and alloys of silicon, tin, aluminum or the like with lithium.

Examples of the binder resin include polyvinylidene fluoride type resins and styrene-butadiene rubbers.

Examples of the conductive auxiliary agent include carbon materials such as acetylene black, ketjen black, and graphite powder.

Examples of the current collector include copper foil, nickel foil, and stainless steel foil which have a thickness of from 5 μm to 20 μm. Further, a metal lithium foil may be used as the negative electrode in place of the above negative electrode.

The electrolyte solution is a solution obtained by dissolving lithium salt in a non-aqueous solvent. Examples of the lithium salt include LiPF₆, LiBF₄, and LiClO₄. Examples of the non-aqueous solvent include cyclic carbonates such as ethylene carbonate, propylene carbonate, fluoroethylene carbonate, difluoroethylene carbonate, and vinylene carbonate; chain carbonates such as dimethyl carbonate, diethyl carbonate, ethyl methyl carbonate, and fluorine substitutes thereof; and cyclic esters such as γ-butyrolactone and γ-valerolactone. The non-aqueous solvents may be used singly, or in mixture of two or more kinds thereof.

The electrolyte solution is preferably an electrolyte solution obtained by mixing cyclic carbonate and chain carbonate at a mass ratio of from 20/80 to 40/60 (=cyclic carbonate/chain carbonate) and dissolving therein a lithium salt in a range of from 0.5 mol to 1.5 mol.

In addition to metal cans, examples of the outer case include soft packs such as aluminum laminate films.

In the case of a configuration in which a polyvinylidene fluoride type resin is used as the binder resin to be used for the separator for a non-aqueous secondary battery of the first or second embodiment, gap formation due to adhesion failure between the electrode and the separator, which is caused by, for example, an impact applied from the outside, electrode expansion and shrinkage accompanied by charging and discharging or electrification accompanied by charging and discharging is suppressed, whereby charge/discharge characteristics (cycle characteristics) become excellent, and further the battery strength (so-called cell strength) is improved. Further, the separator for a non-aqueous secondary battery is favorably adhered to the electrode under appropriate heat pressing temperature conditions, and thus this contributes to an improvement in the quality stability of the soft pack battery.

The battery has a rectangular shape, a cylindrical shape or a coin-like shape, and the separator for a non-aqueous secondary battery described above is preferably formed into any shape.

For example, in the case of a configuration in which a polyvinylidene fluoride type resin is used as the binder resin for the separator for a non-aqueous secondary battery, the non-aqueous secondary battery of the present disclosure may be produced by producing a laminated body in which the separator of the first or second embodiment is disposed between positive and negative electrodes and then using the laminated body, for example, by the following production method 1) or 2).

1) A method including: heat pressing (dry-heat pressing) the laminated body so as to adhere the electrodes to the separator; housing the body in an outer case (e.g., an aluminum laminate film pack, the same applies hereinafter.); injecting an electrolyte solution into the outer case; and heat pressing (wet-heat pressing) the laminated body from the top of the outer case so as to adhere the electrodes to the separator and seal the outer case.

2) A method including: housing the laminated body in an outer case; injecting an electrolyte solution into the outer case; and heat pressing (wet-heat pressing) the laminated body from the top of the outer case so as to adhere the electrodes to the separator and seal the outer case.

According to the production method described in 1), the electrodes are adhered to the separator before the housing of the laminated body in the outer case, thereby suppressing the deformation of the laminated body when conveying the body in order to housing it in the outer case, and thus the strength and dimensional stability of the battery as well as battery characteristics are excellent.

Further, the wet-heat pressing may be performed under moderate conditions at a level that recovers the electrode-separator adhesion which is reduced by impregnation in the electrolyte solution. In other words, the wet-heat pressing temperature can be set to a relatively low temperature. This results in suppression of the generation of gas due to the decomposition of the electrolyte solution and the electrolyte during the battery production, and thus the strength and dimensional stability of the battery as well as battery characteristics are excellent.

Further, the laminated body is further heat pressed in a state in which the polyvinylidene fluoride type resin is swollen with the electrolyte solution, thereby strengthening the adhesion among the electrodes and the separator, and thus the battery strength and the battery characteristics are excellent.

According to the production method described in 2), the laminated body is heat pressed in a state in which the polyvinylidene fluoride type resin is swollen with the electrolyte solution, whereby the electrodes are well adhered to the separator, and thus the battery strength and the battery characteristics are excellent.

Regarding the non-aqueous secondary battery to which the separator of the first or second embodiment is applied, for example, any of the production methods described above may be selected. From the viewpoints of suppressing the deformation of the laminated body corresponding to enlargement of the area of the battery and suppressing the peeling of the electrodes from the separator, the production method described in 1) is preferred.

Regarding the wet-heat pressing conditions in the production methods described in 1) and 2), the pressing pressure is preferably in a range of from 0.5 MPa to 2 MPa and the temperature is preferably in a range of from 70° C. to 110° C. Regarding the dry-heat pressing conditions, the pressing pressure is preferably in a range of from 0.5 MPa to 5 MPa and the temperature is preferably in a range of from 20° C. to 100° C.

In the case of a configuration in which a polyvinylidene fluoride type resin is used as the binder to be used for the separator for a non-aqueous secondary battery of the first or second embodiment, the separator is adhered to the electrode by piling up each other. Therefore, the pressing is not essential in the battery production. However, from the viewpoint of further strengthening the adhesion between the electrode and the separator, it is preferable to perform the pressing. Further, pressing (heat pressing) is preferably performed while heating from the viewpoint of further strengthening the adhesion among the electrodes and the separator.

In the case of producing a laminated body, the method of disposing the separator between the positive electrode and negative electrode may be a method in which at least each one layer of the positive electrode layer, the separator layer, and the negative electrode layer are stacked in this order (so-called stacking method), or a method in which the positive electrode, the separator, the negative electrode, and the separator are piled up in this order and wound together in the longitudinal direction. Note that the term “longitudinal direction” means a longitudinal direction of the separator which is produced into a long shape, and the direction perpendicular to the longitudinal direction of the separator is a “width direction”.

### EXAMPLES

Hereinafter, the embodiments of the present invention will be more specifically described with reference to examples, but the present invention is not limited to the following examples.

[Measurement and Evaluation]

In Examples and Comparative Examples, the following measurement and evaluation were performed. The measurement and evaluation results are shown in Tables 1 to 4 below:

(HFP Content of Polyvinylidene Fluoride Type Resin)

The content ratio (HFP content) of the hexafluoropropylene monomer unit (HFP unit) in the polyvinylidene fluoride type resin was determined from the NMR spectrum. Specifically, the content ratio was determined by dissolving 20 mg of the polyvinylidene fluoride type resin in 0.6 ml of heavy dimethyl sulfoxide at 100° C., and measuring the 19F-NMR spectrum at 100° C.

(Weight-Average Molecular Weight of Polyvinylidene Fluoride Type Resin)

The weight-average molecular weight of the polyvinylidene fluoride type resin was measured by gel permeation chromatography (GPC) under the following conditions and converted to polystyrene equivalents.

<Conditions>
GPC: GPC-900 (manufactured by JASCO Corporation)
Column: TSKgel Super AWM-H (two) (manufactured by TOSOH CORPORATION)
Mobile phase solvent: dimethylformamide (DMF)
Standard sample: mono-disperse polystyrene (manufactured by TOSOH CORPORATION)
Column temperature: 40° C.
Flow rate: 10 ml/min

(Viscosity Ratio of Coating Liquid)

The viscosity of the coating liquid containing a binder resin, zinc oxide particles, and a heat-resistant filler in the first embodiment as well as the viscosity of the coating liquid containing a binder resin and a hexagonal plate-shaped zinc oxide in the second embodiment were measured by the following procedures. In a B-type viscometer (DV-I PRIME, manufactured by Brookfield Engineering Laboratories, Inc.), the measurement spindle (SC4-18) was used, and then the viscosity at a spindle rotation speed of 10 rpm was measured. While the liquid temperature of the coating liquid was maintained at 20° C. using a thermostat bath, the viscosity was measured. The viscosity immediately after adjusting the coating liquid was represented by V0. Further, the coating liquid immediately after adjustment was sealed in a closed container, followed by mixing in a mixing rotor (VMR-5R, manufactured by AS ONE Corporation) at a constant temperature of 25° C. at 70 rpm for 24 hours, and the viscosity of the coating liquid was represented by Vm.

The viscosity ratio of the coating liquid was calculated by the following formula:

The viscosity ratio of the coating liquid=Vm/V0×100

(Aspect Ratio of Hexagonal Plate-Shaped Metal Oxide Particles)

The aspect ratio of the hexagonal plate-shaped metal oxide particles was determined under the following conditions. In an image taken by a scanning electron microscope (SEM), regarding the particles in which the hexagonal surface of the hexagonal plate-shaped particles is facing front, a particle diameter (μm) defined by a unidirectional diameter (interval of two unidirectional parallel lines across the particles; the particles in which the hexagonal surface on the image is facing front are measured unidirectionally) as to 100 particles is measured and the average thereof is represented by L, meanwhile, regarding the particles in which the side surface of the hexagonal plate-shaped particles is facing front (the particles look like rectangular), the thickness (μm) (the length of the short side of a rectangle) as to 100 particles is measured and the average thereof is represented by T. The aspect ratio is determined as the value represented by L/T.

(Membrane Thickness)

The membrane thickness of the separator was measured using a contact thickness meter (LITEMATIC, manufactured by Mitutoyo Corporation). A cylindrical measurement terminal having a diameter of 5 mm was used and adjusted so as to apply a load of 7 g during measurement. Then, the thickness was measured at 20 points and the average thereof was calculated.

(Standard Deviation of Thickness of Heat-Resistant Porous Layer)

The contact thickness meter (LITEMATIC, manufactured by Mitutoyo Corporation) was used along the longitudinal direction of the separator, and the membrane thickness of the separator was measured. A cylindrical measurement terminal having a diameter of 5 mm was used and adjusted so as to apply a load of 7 g during measurement. The thickness was measured at 100 points in the longitudinal direction at intervals of 10 cm and the standard deviation was calculated.

(Appearance Evaluation of Separator)

A commercially available transparent adhesive tape having a width of 48 mm and a length of 300 mm was placed on the separator so as to be horizontal to the width direction of the separator. Thereafter, the tape was sufficiently pressed by strongly rubbing it using a soft cloth and then the tape was removed from the separator. Thus, the adhesive porous layer of the separator was transferred to the transparent adhesive tape. The tape to which the adhesive porous layer was transferred was observed using diffused light. The tape in which the observed number of stripe patterns was 10 or more was evaluated as poor coating appearance, meanwhile, the tape in which the observed number of stripe patterns was less than 10 was evaluated as favorable coating appearance.

(Heat Resistance)

The heat resistance of the separator was evaluated by directly attaching the tip of a soldering iron with a tip diameter of φ2 mm and a tip temperature of 260° C. to a separator cut into a size of 5 cm×5 cm and measuring the area (mm²) of a hole formed when the tip of the soldering iron was attached for 60 seconds.

(Gas Generation Test)

A separator was cut into a size of 600 cm² and used as a sample piece. The sample piece was put in an aluminum laminate film pack, and the separator was impregnated with an electrolyte solution by injecting the electrolyte solution into the pack. After that, the pack was sealed to form a test cell.

Here, the electrolyte solution was 1 mol/L of LiPF₆-ethylene carbonate:ethyl methyl carbonate [mass ratio 3:7].

The produced test cell was placed in a temperature environment of 85° C. and heat-treated for 20 days. Then, the volume of the test cell before and after the heat treatment was measured and a gas yield V (V=V2−V1, unit: ml) was calculated by subtracting a volume V1 of the test cell before the heat treatment from a volume V2 of the test cell after the heat treatment.

(Wet Adhesion Force to Electrode)

91 g of lithium cobalt oxide powder as the positive electrode active material, 3 g of acetylene black as the conductive auxiliary agent, and 3 g of polyvinylidene fluoride as the binder were dissolved in N-methyl-pyrrolidone so that the concentration of polyvinylidene fluoride was 5% by mass and the resulting mixture was stirred with a double-arm mixer to prepare a positive electrode slurry. This positive electrode slurry was applied to one surface of a 20-μm thick aluminum foil and the resulting foil was dried and pressed, thereby obtaining a positive electrode having a positive active material layer (applied to one surface) as an electrode to evaluate the wet adhesion force between the separator and the electrode.

Each of the obtained electrode and aluminum foil (20 μm thick) was cut into a size having a width of 1.5 cm and a length of 7 cm and each of the separators obtained in the following examples and comparative examples was cut into a size having a width of 1.8 cm and a length of 7.5 cm. The electrode, the separator, and the aluminum foil were stacked in this order to form a laminated body. Then, the laminated body was impregnated with an electrolyte solution (1 mol/L LiBF₄-ethylene carbonate:propylene carbonate [mass ratio of 1:1] and housed in an aluminum laminate film pack. After that, the inside of the pack was converted to a vacuum state using a vacuum sealer and the pack including the laminated body was heat-pressed using a heat pressing machine, whereby the electrode was adhered to the separator. The heat-pressing conditions were as follows: pressure, 1 MPa; temperature, 90° C.; and pressing time, 2 minutes.

Thereafter, the pack was opened, the laminated body was taken out, and the aluminum foil was removed from the laminated body, and then the resulting product was used as a measurement sample.

The non-coated surface of the electrode of the measurement sample was fixed to a metal plate with a double-sided tape, and the metal plate was fixed to the bottom fixed chuck of the tensilon (STB-1225S, manufactured by A&D Company, Limited). In this case, the metal plate was fixed to the tensilon so that the length direction of the measurement sample was in the gravity direction. The bottom end of the separator was peeled by about 2 cm from the electrode and the end was fixed to the top of the chuck, whereby the tensile angle (angle of the separator with respect to the measurement sample) was adjusted to 180°. The separator was pulled at a tension rate of 20 mm/min and the load when the separator was peeled from the electrode was measured. From the start of the measurement, the loads from 10 mm to 40 mm were collected at intervals of 0.4 mm. The same measurement was performed 3 times, the average thereof was calculated, and the resulting average was defined as a wet adhesion force to the electrode (N/15 mm; adhesion force between the electrode and the separator by wet-heat pressing).

(Battery Strength)

91 g of lithium cobalt oxide powder as the positive electrode active material, 3 g of acetylene black as the conductive auxiliary agent, and 3 g of polyvinylidene fluoride as the binder were dissolved in N-methyl-pyrrolidone so that the concentration of polyvinylidene fluoride was 5% by mass and the resulting mixture was stirred with a double-arm mixer to prepare a positive electrode slurry. This positive electrode slurry was applied to one surface of a 20-μm thick aluminum foil and the resulting foil was dried and pressed, thereby obtaining a positive electrode having a positive active material layer.

300 g of artificial graphite as the negative electrode active material, 7.5 g of a water-soluble dispersion containing 40% by mass of styrene-butadiene copolymer modified product as the binder, 3 g of carboxymethylcellulose as a thickener, and an appropriate amount of water were stirred and mixed with a double-arm mixer to form a negative electrode slurry. This negative electrode slurry was applied to a 10-μm thick copper foil as the negative electrode current collector and the resulting foil was dried and pressed, thereby obtaining a negative electrode having a negative electrode active material layer.

The positive electrode and the negative electrode were stacked through each of the separators obtained in the following examples and comparative examples and wound up. A lead tab was welded to the resulting product to form a battery element. This battery element was housed in an aluminum laminate film pack and impregnated with an electrolyte solution. Thereafter, the pack was subjected to heat-pressing (wet-heat pressing) at a pressure of 1 MPa, a temperature of 90° C. for 2 minutes and thus the outer case was sealed to form a test secondary battery (length: 65 mm, width: 35 mm, thickness: 2.5 mm, volume: 700 mAh).

Here, the used electrolyte solution was 1 mol/L of LiPF₆-ethylene carbonate:diethyl carbonate (mass ratio 3:7).

The obtained test secondary battery was subjected to a three-point bending test in accordance with ISO-178 and the battery strength (cell strength) was calculated.

(Cycle Characteristics)

A test secondary battery was produced similarly to the production method described in “Battery Strength”.

The produced test secondary battery was used and a charging/discharging cycle was repeated 500 times under the conditions: 4.2 V constant current-constant voltage charging in an environment of 25° C. at 1 C for 2 hours; and 3 V cutoff constant-current discharging at 1 C.

Based on the discharge capacity obtained in the initial cycle, the ratio of the discharge capacity obtained after 500 cycles was expressed in percentage (%;=discharge capacity after 500 cycles/discharge capacity at the time of initial cycle×100), and the value was used as an indicator in evaluating the cycle characteristics.

The embodiment according to the first embodiment will be specifically explained with reference to Examples 1 to 9 and Comparative Examples 1 and 2. Here, Comparative Examples 1 and 2 are exemplary embodiments which are not included in the range of the first embodiment.

### Example 1

As the polyvinylidene fluoride type resin, i.e., the binder resin, a copolymer of vinylidene fluoride (VDF) with hexafluoropropylene (HFP) (VDF-HFP copolymer, VDF:HFP (molar ratio)=97.6:2.4, weight-average molecular weight=1,130,000) was provided. The VDF-HFP copolymer was dissolved in a mixed solvent (dimethylacetamide/tripropylene glycol=80/20 [mass ratio]) so as to have a concentration of 4% by mass, and hexagonal plate-shaped zinc oxide particles (XZ-300F, manufactured by Sakai Chemical Industry Co., Ltd., average particle diameter: 0.3 μm) and magnesium hydroxide (Mg(OH)₂, manufactured by Kyowa Chemical Industry Co., Ltd. (Kisuma 5P, average primary particle diameters 0.8 μm) were added as the filler. The mixture was uniformly stirred to form a coating liquid in which the mass ratio of the VDF-HFP copolymer, zinc oxide, and Mg(OH)₂ was 40:6:54 (=VDF-HFP copolymer:zinc oxide: Mg(OH)₂). The content of zinc oxide particles is 10% by mass with respect to the total amount of zinc oxide particles and Mg(OH)₂, i.e., the heat-resistant filler.

The produced coating liquid was applied to both surfaces of the micro-porous polyethylene membrane, i.e., a porous substrate (membrane thickness: 9 μm, porosity: 40%, Gurley value: 152 sec/100 cc) and the resulting membrane was solidified by immersing in a coagulation liquid (dimethylacetamide/tripropylene glycol/water)=30/8/62 [mass ratio], temperature: 40° C.).

Then, the coated micro-porous polyethylene membrane was washed with water and dried to form a separator having 5-μm thick heat-resistant porous layers formed on both surfaces of the micro-porous polyethylene membrane.

The obtained separator was measured and evaluated as described above. The measurement and evaluation results are shown in Tables 1 and 2 below.

### Example 2

A separator having heat-resistant porous layers formed on both surfaces of a micro-porous polyethylene membrane was produced similarly to Example 1 except that the content of zinc oxide particles was changed from 10% by mass to 20% by mass with respect to the total amount of zinc oxide particles and magnesium hydroxide as the heat-resistant filler (Mg(OH)₂) in Example 1, and the obtained separator was measured and evaluated. The measurement and evaluation results are shown in Tables 1 and 2 below.

### Example 3

A separator having heat-resistant porous layers formed on both surfaces of a micro-porous polyethylene membrane was produced similarly to Example 1 except that the content of zinc oxide particles was changed from 10% by mass to 80% by mass with respect to the total amount of zinc oxide particles and magnesium hydroxide as the heat-resistant filler (Mg(OH)₂) in Example 1, and the obtained separator was measured and evaluated. The measurement and evaluation results are shown in Tables 1 and 2 below.

### Example 4

A separator having heat-resistant porous layers formed on both surfaces of a micro-porous polyethylene membrane was produced similarly to Example 1 except that the content of zinc oxide particles was changed from 10% by mass to 90% by mass with respect to the total amount of zinc oxide particles and magnesium hydroxide as the heat-resistant filler (Mg(OH)₂) in Example 1, and the obtained separator was measured and evaluated. The measurement and evaluation results are shown in Tables 1 and 2 below:

### Example 5

A separator having heat-resistant porous layers formed on both surfaces of a micro-porous polyethylene membrane was produced similarly to Example 1 except that magnesium hydroxide (Mg(OH)₂) was replaced with magnesium oxide (MgO, PUREMAG (registered trademark) FNM-G manufactured by Tateho Chemical Industries Co., Ltd., average primary particle diameter; 0.5 μm) in Example 1, and the obtained separator was measured and evaluated. The measurement and evaluation results are shown in Tables 1 and 2 below.

### Example 6

A separator having heat-resistant porous layers formed on both surfaces of a micro-porous polyethylene membrane was produced similarly to Example 1 except that hexagonal plate-shaped zinc oxide particles (XZ-300F, manufactured by Sakai Chemical Industry Co., Ltd., average particle diameter: 0.3 μm) was replaced with amorphous zinc oxide particles (FINEX30, manufactured by Sakai Chemical Industry Co., Ltd., average particle diameter: 0.03 μm) in Example 1, and the obtained separator was measured and evaluated. The measurement and evaluation results are shown in Tables 1 and 2 below.

### Example 7

A separator having heat-resistant porous layers formed on both surfaces of a micro-porous polyethylene membrane was produced similarly to Example 1 except that hexagonal plate-shaped zinc oxide particles (XZ-300F, manufactured by Sakai Chemical Industry Co., Ltd., average particle diameter: 0.3 μm) was replaced with accumulated plate-shaped spherical zinc oxide particles (CANDY ZINC 1000, manufactured by Sakai Chemical Industry Co., Ltd., average particle diameter: 1.0 μm) in Example 1, and the obtained separator was measured and evaluated. The measurement and evaluation results are shown in Tables 1 and 2 below.

### Example 8

A separator having heat-resistant porous layers formed on both surfaces of a micro-porous polyethylene membrane was produced similarly to Example 1 except that the content of zinc oxide particles was changed from 10% by mass to 2% by mass with respect to the total amount of zinc oxide particles and magnesium hydroxide as the heat-resistant filler (Mg(OH)₂) in Example 1, and the obtained separator was measured and evaluated. The measurement and evaluation results are shown in Tables 1 and 2 below.

### Example 9

A separator having heat-resistant porous layers formed on both surfaces of a micro-porous polyethylene membrane was produced similarly to Example 1 except that the polyvinylidene fluoride type resin, i.e., the binder resin, was replaced with Conex (registered trademark, manufactured by Teijin Techno Products Limited), i.e., the meta-aromatic polyamide (meta-aramid resin) in Example 1, and the obtained separator was measured and evaluated. The measurement and evaluation results are shown in Tables 1 and 2 below.

### Comparative Example 1

A comparative separator having heat-resistant porous layers formed on both surfaces of a micro-porous polyethylene membrane was produced similarly to Example 1 except that zinc oxide particles were not added and the mass ratio of the VDF-HFP copolymer and Mg(OH)₂ was 40:60 in Example 1. The obtained separator was measured and evaluated, similarly to Example 1. The measurement and evaluation results are shown in Tables 1 and 2 below.

### Comparative Example 2

A comparative separator having heat-resistant porous layers formed on both surfaces of a micro-porous polyethylene membrane was produced similarly to Example 5 except that zinc oxide particles were not added and the mass ratio of the VDF-HFP copolymer and MgO was 31:69 in Example 5. The obtained separator was measured and evaluated, similarly to Example 1. The measurement and evaluation results are shown in Tables 1 and 2 below.

TABLE 1

| | | Heat-resistant porous layer | | | | | | |
|---|---|---|---|---|---|---|---|---|
| | | | | | | Zinc oxide particles | | |
| | Coating | | | | | | | Lmin/Lmax |
| | liquid | Binder resin | | | | | | average |
| | Viscosity | | VDF | HFP | | | | measured on |
| | ratio of | | monomer | monomer | Weight-average | | | 100 particles |
| | coating | | unit ratio | unit ratio | molecular | | | observed as |
| | liquid | | [% by | [% by | weight | Presence/ | | the hexagonal |
| | [%] | Kind | mol] | mol] | [Mw × 10⁴] | absence | Shape | surface |
| Example 1 | 115 | VDF-HFP | 97.6 | 2.4 | 113 | Presence | Hexagonal | 0.89 |
| | | | | | | | plate-shaped | |
| Example 2 | 112 | VDF-HFP | 97.6 | 2.4 | 113 | Presence | Hexagonal | 0.89 |
| | | | | | | | plate-shaped | |
| Example 3 | 107 | VDF-HFP | 97.6 | 2.4 | 113 | Presence | Hexagonal | 0.89 |
| | | | | | | | plate-shaped | |
| Example 4 | 106 | VDF-HFP | 97.6 | 2.4 | 113 | Presence | Hexagonal | 0.89 |
| | | | | | | | plate-shaped | |
| Example 5 | 106 | VDF-HFP | 97.6 | 2.4 | 113 | Presence | Hexagonal | 0.89 |
| | | | | | | | plate-shaped | |
| Example 6 | 117 | VDF-HFP | 97.6 | 2.4 | 113 | Presence | Amorphous | — |
| Example 7 | 118 | VDF-HFP | 97.6 | 2.4 | 113 | Presence | Accumulated | — |
| | | | | | | | plate-shaped | |
| | | | | | | | spherical | |
| Example 8 | 115 | VDF-HFP | 97.6 | 2.4 | 113 | Presence | Hexagonal | 0.89 |
| | | | | | | | plate-shaped | |
| Example 9 | 103 | Aramid | 97.6 | 2.4 | 113 | Presence | Hexagonal | 0.89 |
| | | | | | | | plate-shaped | |

| | | | | | | | |
|---|---|---|---|---|---|---|---|
| Comparative | 119 | VDF-HFP | 97.6 | 2.4 | 113 | Absence | — |
| Example 1 | | | | | | | |
| Comparative | 111 | VDF-HFP | 97.6 | 2.4 | 113 | Absence | — |
| Example 2 | | | | | | | |

| | Heat-resistant porous layer | | | | | | |
|---|---|---|---|---|---|---|---|
| | | | | | | | Content of |
| | Zinc oxide particles | | Heat-resistant filler | | | | zinc oxide |
| | Average | | | Average | | | and heat- |
| | primary | | | primary | | | resistant |
| | particle | Content | | particle | Content | C1/(C1 + | filler |
| | diameter | C1 [% by | | diameter | C2 [% by | C2) “% by | “% by |
| | [μm] | mass] | Kind | [μm] | mass] | mass” | volume” |
| Example 1 | 0.3 | 6 | Mg(OH)₂ | 0.8 | 54 | 10 | 52 |
| Example 2 | 0.3 | 12 | Mg(OH)₂ | 0.8 | 48 | 20 | 50 |
| Example 3 | 0.3 | 48 | Mg(OH)₂ | 0.8 | 12 | 80 | 53 |
| Example 4 | 0.3 | 54 | Mg(OH)₂ | 0.8 | 6 | 90 | 53 |
| Example 5 | 0.3 | 6 | MgO | 0.5 | 54 | 10 | 42 |
| Example 6 | 0.03 | 6 | Mg(OH)₂ | 0.8 | 54 | 10 | 52 |
| Example 7 | 1.0 | 6 | Mg(OH)₂ | 0.8 | 54 | 10 | 52 |
| Example 8 | 0.3 | 1.2 | Mg(OH)₂ | 0.3 | 58.8 | 2 | 53 |
| Example 9 | 0.3 | 6 | Mg(OH)₂ | 0.8 | 54 | 10 | 52 |

| | | | | | | |
|---|---|---|---|---|---|---|
| Comparative | — | Mg(OH)₂ | 0.8 | 60 | 0 | 53 |
| Example 1 | | | | | | |
| Comparative | — | MgO | 0.5 | 69 | 0 | 53 |
| Example 2 | | | | | | |

TABLE 2

| | Evaluation | | | | | |
|---|---|---|---|---|---|---|
| | Coating thickness | | | | | Secondary |
| | (total of both | Heat | Gas generation | Wet adhesion | Battery | battery cycle |
| | surfaces) | resistance | test | force | strength | characteristics |
| | [μm] | [mm²] | [ml] | [N/15 mm] | [N] | [%] |
| Example 1 | 5 | 8.1 | 2 | 0.28 | 255 | 86 |
| Example 2 | 5 | 7.9 | 2 | 0.25 | 240 | 87 |
| Example 3 | 5 | 7.9 | 1 | 0.21 | 233 | 87 |
| Example 4 | 5 | 8.0 | 1 | 0.21 | 232 | 88 |
| Example 5 | 5 | 8.3 | 2 | 0.30 | 248 | 85 |
| Example 6 | 5 | 7.3 | 2 | 0.14 | 149 | 81 |
| Example 7 | 5 | 8.7 | 2 | 0.17 | 157 | 82 |
| Example 8 | 5 | 8.0 | 4 | 0.31 | 257 | 84 |
| Example 9 | 5 | 0.0 | 2 | 0.00 | 60 | 78 |
| Comparative | 5 | 7.0 | 8 | 0.31 | 260 | 81 |
| Example 1 | | | | | | |
| Comparative | 5 | 8.9 | 7 | 0.18 | 162 | 81 |
| Example 2 | | | | | | |

As shown in Tables 1 and 2, the separators of the examples obtained by using one or more heat-resistant filler selected from the group consisting of a metal hydroxide and a metal oxide other than zinc oxide in combination with zinc oxide particles at a predetermined ratio exhibited favorable heat resistance, and the generation of gas due to the decomposition of the electrolyte solution was suppressed and a change (deformation) in the battery shape due to swelling was also suppressed. Further, the adhesion by wet-heat pressing in each example containing the VDF-HFP copolymer as the binder resin was more favorable than that in Example 9 containing aramid (i.e., another resin) and the strength of the produced battery was also excellent.

Meanwhile, like Comparative Example 1, the use of the composition containing only the heat-resistant filler and not containing the zinc oxide particles resulted in an improving effect of the heat resistance and the battery strength by the filler. However, the generation of gas due to the decomposition of the electrolyte solution was frequently confirmed.

The embodiment according to the second embodiment will be specifically explained with reference to Examples 10 to 21 and Comparative Examples 3 to 6. Here, Comparative Examples 3 to 6 are exemplary embodiments which are not included in the range of the second embodiment.

### Example 10

As the polyvinylidene fluoride type resin, i.e., the binder resin, a copolymer of vinylidene fluoride (VDF) with hexafluoropropylene (HFP) (VDF-HFP copolymer, VDF:HFP (molar ratio)=97.6:2.4, weight-average molecular weight=1,130,000) was provided. The VDF-HFP copolymer was dissolved in a mixed solvent (dimethylacetamide/tripropylene glycol=80/20 [mass ratio]) so as to have a concentration of 4% by mass, and hexagonal plate-shaped zinc oxide particles (XZ-300F. manufactured by Sakai Chemical Industry Co., Ltd., average particle diameter: 0.3 μm) was added as the filler. The mixture was uniformly stirred to form a coating liquid in which the mass ratio of the VDF-HFP copolymer and zinc oxide particles was 22:78 (=VDF-HFP copolymer:zinc oxide particles).

The produced coating liquid was applied to both surfaces of the micro-porous polyethylene membrane, i.e., a porous substrate (membrane thickness: 9 μm, porosity: 40%, Gurley value: 152 sec/100 cc) and the resulting membrane was solidified by immersing in a coagulation liquid (dimethylacetamide/tripropylene glycol/water)=30/8/62 [mass ratio], temperature: 40° C.).

Then, the coated micro-porous polyethylene membrane was washed with water and dried to form a separator having 5-μm thick heat-resistant porous layers formed on both surfaces of the micro-porous polyethylene membrane. In the formed heat-resistant porous layer, the volume ratio of zinc oxide in the heat-resistant porous layer was 53% by volume.

The obtained separator was measured and evaluated as described above. The measurement and evaluation results are shown in Tables 3 and 4 below.

### Example 11

A separator having heat-resistant porous layers formed on both surfaces of a micro-porous polyethylene membrane was produced similarly to Example 10 except that hexagonal plate-shaped zinc oxide particles (XZ-300F, manufactured by Sakai Chemical Industry Co., Ltd., average particle diameter: 0.3 μm) was replaced with hexagonal plate-shaped zinc oxide particles (XZ-100F, manufactured by Sakai Chemical Industry Co., Ltd., average particle diameter: 0.1 μm) in Example 10, and the obtained separator was measured and evaluated. The measurement and evaluation results are shown in Tables 3 and 4 below.

### Example 12

A separator having heat-resistant porous layers formed on both surfaces of a micro-porous polyethylene membrane was produced similarly to Example 10 except that hexagonal plate-shaped zinc oxide particles (XZ-300F, manufactured by Sakai Chemical Industry Co., Ltd., average particle diameter: 0.3 μm) was replaced with hexagonal plate-shaped zinc oxide particles (XZ-1000F, manufactured by Sakai Chemical Industry Co., Ltd., average particle diameter: 1.0 μm) in Example 10, and the obtained separator was measured and evaluated. The measurement and evaluation results are shown in Tables 3 and 4 below.

### Example 13

As the polyvinylidene fluoride type resin, i.e., the binder resin, a copolymer of vinylidene fluoride (VDF) with hexafluoropropylene (HFP) (VDF-HFP copolymer, VDF: HFP (molar ratio)=97.6:2.4, weight-average molecular weight=1,130,000) was provided. The VDF-HFP copolymer was dissolved in a mixed solvent (dimethylacetamide/tripropylene glycol=80/20 [mass ratio]) so as to have a concentration of 4% by mass, and hexagonal plate-shaped zinc oxide particles (XZ-300F, manufactured by Sakai Chemical Industry Co., Ltd., average particle diameter: 0.3 μm) and magnesium hydroxide (Mg(OH)₂, manufactured by Kyowa Chemical Industry Co., Ltd. (Kisuma 5P, average primary particle diameters 0.8 μm) were added as the filler. The mixture was uniformly stirred to form a coating liquid in which the mass ratio of the VDF-HFP copolymer, zinc oxide, and Mg(OH)₂ was 40:6:54 (=VDF-HFP copolymer:zinc oxide: Mg(OH)₂). The content of zinc oxide particles is 10% by mass with respect to the total amount of zinc oxide particles and Mg(OH)₂.

A separator having heat-resistant porous layers formed on both surfaces of a micro-porous polyethylene membrane was produced similarly to Example 10, and the obtained separator was measured and evaluated. The measurement and evaluation results are shown in Tables 3 and 4 below.

### Example 14

A separator having heat-resistant porous layers formed on both surfaces of a micro-porous polyethylene membrane was produced similarly to Example 13 except that the content of zinc oxide particles was changed from 10% by mass to 20% by mass with respect to the total amount of zinc oxide particles and magnesium hydroxide (Mg(OH)₂) in Example 13, and the obtained separator was measured and evaluated. The measurement and evaluation results are shown in Tables 3 and 4 below.

### Example 15

A separator having heat-resistant porous layers formed on both surfaces of a micro-porous polyethylene membrane was produced similarly to Example 13 except that the content of zinc oxide particles was changed from 10% by mass to 2% by mass with respect to the total amount of zinc oxide particles and magnesium hydroxide (Mg(OH)₂) in Example 13, and the obtained separator was measured and evaluated. The measurement and evaluation results are shown in Tables 3 and 4 below.

### Example 16

A separator having heat-resistant porous layers formed on both surfaces of a micro-porous polyethylene membrane was produced similarly to Example 10 except that the VDF-HFP copolymer was replaced with Conex (registered trademark, manufactured by Teijin Techno Products Limited). i.e., meta-aromatic polyamide (meta-aramid resin) in Example 10, and the obtained separator was measured and evaluated. The measurement and evaluation results are shown in Tables 3 and 4 below.

### [Example 17]

A separator having heat-resistant porous layers formed on both surfaces of a micro-porous polyethylene membrane was produced similarly to Example 13 except that magnesium hydroxide (Mg(OH)₂) was replaced with magnesium oxide (MgO, PUREMAG (registered trademark) FNM-G manufactured by Tateho Chemical Industries Co., Ltd., average primary particle diameter; 0.5 μm) in Example 13, and the obtained separator was measured and evaluated. The measurement and evaluation results are shown in Tables 3 and 4 below.

### Example 18

A separator having heat-resistant porous layers formed on both surfaces of a micro-porous polyethylene membrane was produced similarly to Example 10 except that the weight-average molecular weight of the VDF-HFP copolymer was changed from 1,130,000 to 2,000,000 in Example 10, and the obtained separator was measured and evaluated. The measurement and evaluation results are shown in Tables 3 and 4 below:

### Example 19

A separator having heat-resistant porous layers formed on both surfaces of a micro-porous polyethylene membrane was produced similarly to Example 10 except that the copolymerization ratio of hexafluoropropylene (HFP) was changed from 2.4% by mol to 5.8% by mol in Example 10. The measurement and evaluation results are shown in Tables 3 and 4 below.

### Example 201

A separator having heat-resistant porous layers formed on both surfaces of a micro-porous polyethylene membrane was produced similarly to Example 10 except that the content of zinc oxide particles in the heat-resistant porous layer was changed from 53% by volume to 45% by volume in Example 10, and the obtained separator was measured and evaluated. The measurement and evaluation results are shown in Tables 3 and 4 below.

### Example 21

A separator having heat-resistant porous layers formed on both surfaces of a micro-porous polyethylene membrane was produced similarly to Example 10 except that the content of zinc oxide particles in the heat-resistant porous layer was changed from 53% by volume to 73% by volume in Example 10, and the obtained separator was measured and evaluated. The measurement and evaluation results are shown in Tables 3 and 4 below.

### Comparative Example 3

A comparative separator having heat-resistant porous layers formed on both surfaces of a micro-porous polyethylene membrane was produced similarly to Example 13 except that hexagonal plate-shaped zinc oxide particles were not added and the mass ratio of the VDF-HFP copolymer and Mg(OH)₂ was 40:60 in Example 13. The obtained separator was measured and evaluated, similarly to Example 10. The measurement and evaluation results are shown in Tables 3 and 4 below.

### Comparative Example 4

A comparative separator having heat-resistant porous layers formed on both surfaces of a micro-porous polyethylene membrane was produced similarly to Example 10 except that hexagonal plate-shaped zinc oxide particles (XZ-300F, manufactured by Sakai Chemical Industry Co., Ltd., average particle diameter: 0.3 μm) was replaced with amorphous zinc oxide particles (FINEX30, manufactured by Sakai Chemical Industry Co., Ltd., average particle diameter: 0.03 μm) in Example 10. The measurement and evaluation were performed on the obtained separator. The measurement and evaluation results are shown in Tables 3 and 4 below.

### Comparative Example 51

A comparative separator having heat-resistant porous layers formed on both surfaces of a micro-porous polyethylene membrane was produced similarly to Example 10 except that hexagonal plate-shaped zinc oxide particles (XZ-300F, manufactured by Sakai Chemical Industry Co., Ltd., average particle diameter: 0.3 μm) was replaced with accumulated plate-shaped spherical zinc oxide particles (CANDY ZINC 1000, manufactured by Sakai Chemical Industry Co., Ltd., average particle diameter: 1.0 μm) in Example 10, and the obtained separator was measured and evaluated. The measurement and evaluation results are shown in Tables 3 and 4 below.

### Comparative Example 6

A comparative separator having heat-resistant porous layers formed on both surfaces of a micro-porous polyethylene membrane was produced similarly to Example 17 except that hexagonal plate-shaped zinc oxide particles were not added and the mass ratio of the VDF-HFP copolymer and MgO was 31:69 in Example 17. The obtained separator was measured and evaluated, similarly to Example 10. The measurement and evaluation results are shown in Tables 3 and 4 below.

TABLE 3

| | Coating | Heat-resistant porous layer | | | | | | |
|---|---|---|---|---|---|---|---|---|
| | liquid | Binder resin | | | | Zinc oxide particles | | |
| | Viscosity | | | | Weight- | | | Lmin/Lmax average |
| | ratio of | | VDF | HFP | average | | | measured on 100 |
| | coating | | monomer | monomer | molecular | | | particles observed |
| | liquid | | unit ratio | unit ratio | weight | Presence/ | | as the hexagonal |
| | [%] | Kind | [% by mol] | [% by mol] | [Mw × 10⁴] | absence | Shape | surface |
| Example 10 | 104 | VDF-HFP | 97.6 | 2.4 | 113 | Presence | Hexagonal plate- | 0.89 |
| | | | | | | | shaped | |
| Example 11 | 109 | VDF-HFP | 97.6 | 2.4 | 113 | Presence | Hexagonal plate- | 0.89 |
| | | | | | | | shaped | |
| Example 12 | 110 | VDF-HFP | 97.6 | 2.4 | 113 | Presence | Hexagonal plate- | 0.89 |
| | | | | | | | shaped | |
| Example 13 | 115 | VDF-HFP | 97.6 | 2.4 | 113 | Presence | Hexagonal plate- | 0.89 |
| | | | | | | | shaped | |
| Example 14 | 112 | VDF-HFP | 97.6 | 2.4 | 113 | Presence | Hexagonal plate- | 0.89 |
| | | | | | | | shaped | |
| Example 15 | 115 | VDF-HFP | 97.6 | 2.4 | 113 | Presence | Hexagonal plate- | 0.89 |
| | | | | | | | shaped | |
| Example 16 | 103 | Aramid | — | | | Presence | Hexagonal plate- | 0.89 |
| | | | | | | | shaped | |
| Example 17 | 106 | VDF-HFP | 97.6 | 2.4 | 113 | Presence | Hexagonal plate- | 0.89 |
| | | | | | | | shaped | |
| Example 18 | 107 | VDF-HFP | 97.6 | 2.4 | 200 | Presence | Hexagonal plate- | 0.89 |
| | | | | | | | shaped | |
| Example 19 | 103 | VDF-HFP | 94.2 | 5.8 | 113 | Presence | Hexagonal plate- | 0.89 |
| | | | | | | | shaped | |
| Example 20 | 102 | VDF-HFP | 97.6 | 2.4 | 113 | Presence | Hexagonal plate- | 0.89 |
| | | | | | | | shaped | |
| Example 21 | 103 | VDF-HFP | 97.6 | 2.4 | 113 | Presence | Hexagonal plate- | 0.89 |
| | | | | | | | shaped | |
| Comparative | 119 | VDF-HFP | 97.6 | 2.4 | 113 | Absence | — | |
| Example 3 | | | | | | | | |
| Comparative | 118 | VDF-HFP | 97.6 | 2.4 | 113 | Presence | Amorphous | — |
| Example 4 | | | | | | | | |
| Comparative | 121 | VDF-HFP | 97.6 | 2.4 | 113 | Presence | Accumulated plate- | — |
| Example 5 | | | | | | | shaped spherical | |

| | | | | | | | |
|---|---|---|---|---|---|---|---|
| Comparative | 111 | VDF-HFP | 97.6 | 2.4 | 113 | Absence | — |
| Example 6 | | | | | | | |

| | Heat-resistant porous layer | | | | | | | |
|---|---|---|---|---|---|---|---|---|
| | Zinc oxide particles | | | Inorganic filler | | | | |
| | | Average | | | Average | | | |
| | | primary | Content | | primary | | C1/(C1 + | Content of zinc |
| | | particle | C1 | | particle | Content C2 | C2) | oxide and |
| | Aspect | diameter | [% by | | diameter | [% by | [% by | inorganic filler |
| | ratio | [μm] | mass] | Kind | [μm] | mass] | mass] | [% by volume] |
| Example 10 | 3.7 | 0.3 | 78 | — | | | 100 | 53 |
| Example 11 | 3.4 | 0.1 | 78 | — | | | 100 | 53 |
| Example 12 | 3.4 | 1.0 | 78 | — | | | 100 | 53 |
| Example 13 | 3.7 | 0.3 | 6 | Mg (OH)₂ | 0.8 | 54 | 10 | 52 |
| Example 14 | 3.7 | 0.3 | 12 | Mg (OH)₂ | 0.8 | 48 | 20 | 50 |
| Example 15 | 3.7 | 0.3 | 1.2 | Mg (OH)₂ | 0.8 | 58.8 | 2 | 53 |
| Example 16 | 3.7 | 0.3 | 78 | — | | | 100 | 53 |
| Example 17 | 3.7 | 0.3 | 6 | MgO | 0.5 | 54 | 10 | 42 |

| | | | | | | |
|---|---|---|---|---|---|---|
| Example 18 | 3.7 | 0.3 | 78 | — | 100 | 53 |
| Example 19 | 3.7 | 0.3 | 78 | — | 100 | 53 |
| Example 20 | 3.7 | 0.3 | 71 | — | 100 | 45 |
| Example 21 | 3.7 | 0.3 | 90 | — | 100 | 73 |

| | | | | | | |
|---|---|---|---|---|---|---|
| Comparative | — | Mg (OH)₂ | 0.8 | 60 | 0 | 53 |
| Example 3 | | | | | | |

| | | | | | | |
|---|---|---|---|---|---|---|
| Comparative | — | 0.03 | 78 | — | 100 | 53 |
| Example 4 | | | | | | |
| Comparative | — | 1.0 | 78 | — | 100 | 53 |
| Example 5 | | | | | | |

| | | | | | | |
|---|---|---|---|---|---|---|
| Comparative | — | MgO | 0.5 | 69 | 0 | 53 |
| Example 6 | | | | | | |

TABLE 4

| | Evaluation | | | | | | | |
|---|---|---|---|---|---|---|---|---|
| | Coating | | | | | | | |
| | thickness | Standard | | | | | | |
| | (total of | deviation of | | | Gas | Wet | | Secondary |
| | both | thickness of | | Heat | generation | adhesion | Battery | battery cycle |
| | surfaces) | heat-resistant | Appearance | resistance | test | force | strength | characteristics |
| | [μm] | porous layer | evaluation | [mm²] | [ml] | [N/15 mm] | [N] | [%] |
| Example 10 | 5 | 0.1 | Favorable | 8.5 | 1 | 0.28 | 230 | 90 |
| Example 11 | 5 | 0.1 | Favorable | 7.6 | 1 | 0.20 | 180 | 88 |
| Example 12 | 5 | 0.1 | Favorable | 9.1 | 1 | 0.23 | 160 | 90 |
| Example 13 | 5 | 0.1 | Favorable | 8.1 | 2 | 0.28 | 255 | 86 |
| Example 14 | 5 | 0.1 | Favorable | 7.9 | 2 | 0.25 | 240 | 87 |
| Example 15 | 5 | 0.1 | Favorable | 8.0 | 4 | 0.31 | 257 | 84 |
| Example 16 | 5 | 0.1 | Favorable | 0 | 1 | 0.00 | 54 | 78 |
| Example 17 | 5 | 0.2 | Favorable | 8.3 | 2 | 0.30 | 248 | 85 |
| Example 18 | 5 | 0.1 | Favorable | 8.2 | 1 | 0.32 | 250 | 88 |
| Example 19 | 5 | 0.1 | Favorable | 8.4 | 1 | 0.26 | 200 | 86 |
| Example 20 | 5 | 0.1 | Favorable | 9.3 | 1 | 0.33 | 230 | 88 |
| Example 21 | 5 | 0.1 | Favorable | 7.9 | 1 | 0.20 | 180 | 86 |
| Comparative | 5 | 0.2 | Poor | 7.0 | 8 | 0.31 | 260 | 81 |
| Example 3 | | | | | | | | |
| Comparative | 5 | 0.2 | Poor | 7.7 | 3 | 0.21 | 182 | 89 |
| Example 4 | | | | | | | | |
| Comparative | 5 | 0.2 | Poor | 9.5 | 3 | 0.18 | 170 | 86 |
| Example 5 | | | | | | | | |
| Comparative | 5 | 0.3 | Poor | 8.9 | 7 | 0.18 | 162 | 81 |
| Example 6 | | | | | | | | |

As shown in Tables 3 and 4, as shown in Comparative Examples 3 and 6, the use of the composition which containing only inorganic fillers other than the hexagonal plate-shaped zinc oxide particles and not containing the hexagonal plate-shaped zinc oxide particles resulted in an increase in the viscosity ratio of the coating liquid and in an improving effect of the heat resistance and the battery strength by the filler. However, the generation of gas due to the decomposition of the electrolyte solution was frequently confirmed. Meanwhile, in the examples containing the hexagonal plate-shaped zinc oxide particles in the heat-resistant porous layer, the viscosity ratio of the coating liquid was suppressed, and a separator having little fluctuation in the membrane thickness and a favorable appearance was obtained. Further, as shown in Comparative Examples 4 and 5, the separators of the examples containing the hexagonal plate-shaped zinc oxide particles exhibited favorable heat resistance, compared to the cases of containing the zinc oxide particles, which were not hexagonal plate-shaped, and the generation of gas due to the decomposition of the electrolyte solution or the like was suppressed. Further, the adhesion by wet-heat pressing in each example containing the VDF-HFP copolymer as the binder resin was more favorable than that in Example 16 containing aramid (i.e., another resin) and the strength of the produced battery was also excellent.

What is claimed is:

1. A separator for a non-aqueous secondary battery, comprising:
a porous substrate; and
a heat-resistant porous layer that is provided on one side or both sides of the porous substrate, wherein:
the heat-resistant porous layer contains (1) a binder resin, (2) zinc oxide particles, and (3) one or more heat-resistant filler selected from the group consisting of a metal hydroxide and a metal oxide other than zinc oxide, and
a content of the zinc oxide particles is 2% by mass or more and less than 100% by mass with respect to a total content of the zinc oxide particles and the heat-resistant filler.

2. The separator for a non-aqueous secondary battery according to claim 1, wherein the heat-resistant filler is one or more heat-resistant filler selected from the group consisting of magnesium hydroxide, aluminum hydroxide, aluminum oxide, boehmite, and magnesium oxide.

3. The separator for a non-aqueous secondary battery according to claim 1, wherein an average particle diameter of the zinc oxide particles is from 0.1 μm to 1 μm.

4. The separator for a non-aqueous secondary battery according to claim 1, wherein:
the binder resin is a copolymer including a vinylidene fluoride monomer unit and a hexafluoropropylene monomer unit, and
the binder resin is a polyvinylidene fluoride type resin including the hexafluoropropylene monomer unit in an amount of from 1.0% by mol to 7.0% by mol with respect to a total amount of the vinylidene fluoride monomer unit and the hexafluoropropylene monomer unit.

5. The separator for a non-aqueous secondary battery according to claim 4, wherein a weight-average molecular weight of the polyvinylidene fluoride type resin is from 600,000 to 3,000,000.

6. The separator for a non-aqueous secondary battery according to claim 1, wherein a total content of the zinc oxide particles and the heat-resistant filler in the heat-resistant porous layer is from 30% by volume to 85% by volume.

7. A non-aqueous secondary battery comprising:
a positive electrode,
a negative electrode, and
the separator for a non-aqueous secondary battery according to claim 1, which is disposed between the positive electrode and the negative electrode,
wherein an electromotive force is obtained by lithium doping and dedoping.

8. A separator for a non-aqueous secondary battery, comprising:
a porous substrate; and
a heat-resistant porous layer that is provided on one side or both sides of the porous substrate and contains a binder resin and hexagonal plate-shaped zinc oxide particles.

9. The separator for a non-aqueous secondary battery according to claim 8, wherein an average particle diameter of the hexagonal plate-shaped zinc oxide particles is from 0.1 μm to 1 μm.

10. The separator for a non-aqueous secondary battery according to claim 8, wherein:
the binder resin is a copolymer including a vinylidene fluoride monomer unit and a hexafluoropropylene monomer unit, and
the binder resin is a polyvinylidene fluoride type resin including the hexafluoropropylene monomer unit in an amount of from 1.0% by mol to 7.0% by mol with respect to a total amount of the vinylidene fluoride monomer unit and the hexafluoropropylene monomer unit.

11. The separator for a non-aqueous secondary battery according to claim 10, wherein a weight-average molecular weight of the polyvinylidene fluoride type resin is from 600,000 to 3,000,000.

12. A non-aqueous secondary battery comprising:
a positive electrode,
a negative electrode, and
the separator for a non-aqueous secondary battery according to claim 8, which is disposed between the positive electrode and the negative electrode,
wherein an electromotive force is obtained by lithium doping and dedoping.
